(19) United States
(12) Patent Application Publication
(10) Pub. No.: US 2011/0286672 A1
(43) Pub. Date: Nov. 24, 2011

(54) TRANSLUCENT IMAGE DETECTION APPARATUS, TRANSLUCENT IMAGE EDGE DETECTION APPARATUS, TRANSLUCENT IMAGE DETECTION METHOD, AND TRANSLUCENT IMAGE EDGE DETECTION METHOD

(75) Inventor: Tomoo YAMANAKA, Toyokawa-shi (JP)

(73) Assignee: Konica Minolta Business Technologies, Inc.., Tokyo (JP)

(21) Appl. No.: 13/109,627

(22) Filed: May 17, 2011

(30) Foreign Application Priority Data
May 18, 2010 (JP) 2010-114486

(51) Int. Cl. G06K 9/48

(52) U.S. Cl. 382/199

(57) ABSTRACT

A translucent image edge detection apparatus is provided with a detector that detects isolated point pixels in an image, the isolated point pixels being pixels having a density higher than that of neighboring pixels adjacent to the isolated point pixels; a determination portion that detects periodic pixels from the isolated point pixels, the periodic pixels being seen at regular intervals; a closing processing portion that performs closing processing on a region containing the periodic pixels, and thereby, obtains a post-closing region; an expanded region calculation portion that obtains an expanded region by expanding the post-closing region; a reduced region calculation portion that obtains a reduced region by reducing the post-closing region; and an edge calculation portion that detects an edge of a translucent image based on a difference between the expanded region and the reduced region.

This application is based on Japanese patent application No. 2010-114486 filed on May 18, 2010, the contents of which are hereby incorporated by reference.

### BACKGROUND OF THE INVENTION

1. Field of the Invention

The present invention relates to an apparatus and method for detecting a translucent image or an edge thereof.

2. Description of the Related Art

Image forming apparatuses having a variety of functions, such as copying, PC printing, scanning, faxing, and file server, have recently come into widespread use. Such image forming apparatuses are sometimes called “multifunction devices”, “Multi-Function Peripherals (MFPs)”, or the like.

The PC printing function is to receive image data from a personal computer and to print an image onto paper based on the image data.

In recent years, applications used for drawing in a personal computer have been available in the market. Such applications are called “drawing software”. Some pieces of drawing software are equipped with a function to show a translucent image on a display.

The “translucent image” herein has properties which allow another object image placed in the rear thereof to be visible through the translucent image itself. Referring to FIG. 4A, for example, a circular translucent image 50a is placed in the foreground, or, in other words, placed above or on a rectangular rear image 50b. However, a part of the rear image 50b overlapping the translucent image 50a is visible through the translucent image 50a. Higher transmissivity of the translucent image 50a allows the rear image 50b to be more visible therethrough. In short, the translucent image is an image representing a translucent object.

An image forming apparatus is capable of printing, onto paper, a translucent image displayed on a personal computer. Before the translucent image is printed out, the translucent image undergoes a pixel decimation process depending on the level of the transmissivity thereof (see FIG. 6A). Then, another image, placed in the back of the translucent image, is printed at positions of pixels that have been decimated from the translucent image. In this way, the other image is visible through the translucent image.

The pixels of the translucent image are decimated at regular intervals depending on the transmissivity thereof. The translucent image is, thus, similar to a so-called halftone dots image in that pixels having density and pixels having no density are disposed at regular intervals.

In printing a translucent image, an edge (contour) thereof is sometimes enhanced. In order to enhance the edge of the translucent image, it is required to specify the position of the edge. The following method has been proposed as a method for specifying the position of the edge.

Each pixel is regarded as a pixel of interest, and four of the neighboring pixels, which are disposed on the left, right, top, and bottom of the pixel of interest, are successively extracted. Then, it is determined whether or not the pixel of interest is an edge pixel in the following manner. First, a density difference between the pixel of interest and the first neighboring pixel is calculated, and then, the calculated density difference is compared with a constant value. If the calculated density difference is smaller than the constant value, then a density difference between the pixel of interest and the second neighboring pixel is obtained, and then, the obtained density difference is compared with the constant value. Likewise, if the obtained density difference is smaller than the constant value, then a density difference between the pixel of interest and the third neighboring pixel is obtained. Then, if the obtained density difference is smaller than the constant value, then a density difference between the pixel of interest and the fourth neighboring pixel is calculated. As a result, if the calculated density difference is also smaller than the constant value, then it is determined that the pixel of interest is not an edge pixel. On the other hand, if any one of the four calculated density differences exceeds the constant value, then it is determined that the pixel of interest is an edge pixel (Japanese Laid-open Patent Publication No. 5-236260).

There has been proposed another method in which a photographic area, a text area, and a dot area contained in an image are separated from one another (Japanese Laid-open Patent Publication No. 8-237475). Further, another method has been proposed for detecting a character edge in halftone dots (Japanese Laid-open Patent Publication No. 2002-218235).

As discussed earlier, pixels of a translucent image are decimated depending on the level of transmissivity thereof (see FIG. 6A). Thus, a density difference is observed between a part corresponding to the decimated pixel and a part corresponding to a remaining pixel. In the conventional methods, such a density difference may lead to an erroneous determination that an edge is present between the part corresponding to the decimated pixel and the part corresponding to the remaining pixel.

### SUMMARY

The present disclosure is directed to solve the problems pointed out above, and therefore, an object of an embodiment of the present invention is to improve the accuracy of detection of an edge of a translucent image as compared to conventional techniques.

According to an aspect of the present invention, a translucent image edge detection apparatus includes a first detector that detects first isolated point pixels in an image, the first isolated point pixels being pixels having a first density higher than a density of neighboring pixels adjacent to the first isolated point pixels by a value of a first threshold or larger, a second detector that detects second isolated point pixels in the image, the second isolated point pixels being pixels having a second density higher than a density of neighboring pixels adjacent to the second isolated point pixels by a value of a second threshold or larger, the second threshold being lower than the first threshold, a selection portion that selects third isolated point pixels in the image, the third isolated point pixels being pixels that are not detected as the first isolated point pixels and are detected as the second isolated point pixels, a third detector that detects an edge of a translucent image in the image, and a deletion portion that deletes, from the edge detected by the third detector, a part of the edge overlapping a region obtained by dilating the third isolated point pixels.

According to another aspect of the present invention, a translucent image edge detection apparatus includes a closing processing portion that, if attribute data of a translucent image indicates positions of pixels having at least a constant density in the translucent image, performs closing processing on an image showing distribution of the pixels, and thereby, obtains a post-closing region; an expanded region calculation portion that obtains an expanded region by expanding the post-closing region; a reduced region calculation portion that obtains a reduced region by reducing the post-closing region; and a translucent image edge calculation portion that detects an edge of a translucent image based on a difference between the expanded region and the reduced region.

According to another aspect of the present invention, a translucent image detection apparatus includes an isolated point pixel detector that detects isolated point pixels in an image, the isolated point pixels being pixels having a density higher than that of neighboring pixels adjacent to the isolated point pixels; a determination portion that detects periodic pixels from the isolated point pixels, the periodic pixels being seen at regular intervals; and a translucent image detector that detects, as a translucent image, a region obtained by dilating the periodic pixels.

According to another aspect of the present invention, a translucent image edge detection apparatus includes a detector that detects isolated point pixels in an image, the isolated point pixels being pixels having a density higher than that of neighboring pixels adjacent to the isolated point pixels; a determination portion that detects periodic pixels from the isolated point pixels, the periodic pixels being seen at regular intervals; a closing processing portion that performs closing processing on a region containing the periodic pixels, and thereby, obtains a post-closing region; an expanded region calculation portion that obtains an expanded region by expanding the post-closing region; a reduced region calculation portion that obtains a reduced region by reducing the post-closing region; and an edge calculation portion that detects an edge of a translucent image based on a difference between the expanded region and the reduced region.

According to another aspect of the present invention, a translucent image edge detection apparatus includes an obtaining portion that obtains attribute data indicating a position and a shape of a translucent image; an expanded region calculation portion that obtains an expanded region by expanding a region of the translucent image based on the attribute data; a reduced region calculation portion that obtains a reduced region by reducing a region of the translucent image based on the attribute data; and a translucent image edge calculation portion that detects an edge of the translucent image based on a difference between the expanded region and the reduced region.

These and other characteristics and objects of the present invention will become more apparent by the following descriptions of preferred embodiments with reference to drawings.

### BRIEF DESCRIPTION OF THE DRAWINGS

FIG. 1 is a diagram illustrating an example of a network system including an image forming apparatus.

FIG. 2 is a diagram illustrating an example of the hardware configuration of an image forming apparatus.

FIG. 3 is a diagram illustrating an example of the configuration of an image processing circuit.

FIGS. 4A and 4B are diagrams illustrating an example of the positional relationship between a translucent image and a rear image both of which are contained in a document image.

FIG. 5 is a diagram illustrating an example of the configuration of an edge enhancement region detection portion for a case where a first edge enhancement region detection method is employed.

FIGS. 6A to 6C are diagrams illustrating an example of attribute images in which attributes of translucent images are shown.

FIG. 7 is a diagram illustrating an example as to how a translucent image and a rear image overlap with each other in pixels.

FIG. 8 is a diagram illustrating an example as to how isolated point pixels and non-isolated point pixels are disposed.

FIG. 9 is a diagram illustrating an example of the ranges of isolated point pixels after expansion.

FIG. 10 is a diagram illustrating an example of the configuration of an edge enhancement region detection portion for a case where a second edge enhancement region detection method is employed.

FIG. 11 is a diagram illustrating an example of the configuration of an edge enhancement region detection portion for a case where a third edge enhancement region detection method is employed.

FIG. 12 is a diagram illustrating an example of the configuration of an edge enhancement region detection portion for a case where a fourth edge enhancement region detection method is employed.

FIGS. 13A to 13C are diagrams illustrating an example of a translucent image expressed in gradations.

FIG. 14 is a diagram illustrating an example of the configuration of an edge enhancement region detection portion for a case where a fifth edge enhancement region detection method is employed.

FIGS. 15A and 15B are diagrams illustrating an example of the positional relationship among isolated point pixels, temporary isolated point pixels, and non-isolated point pixels.

FIGS. 16A to 16C are diagrams illustrating an example of the positional relationship among a translucent image, a rear image, and an edge enhancement region.

FIG. 17 is a diagram illustrating an example of the configuration of an edge enhancement region detection portion for a case where a sixth edge enhancement region detection method is employed.

FIG. 18 is a diagram illustrating an example of the configuration of an edge enhancement region detection portion for a case where a seventh edge enhancement region detection method is employed.

FIG. 19 is a diagram illustrating an example of the configuration of an edge enhancement region detection portion for a case where an eighth edge enhancement region detection method is employed.

FIGS. 20A to 20C are diagrams illustrating an example of regions in which an isolated point pixel is detected.

FIG. 21 is a diagram illustrating an example of the configuration of an edge enhancement region detection portion for a case where a ninth edge enhancement region detection method is employed.

FIG. 22 is a diagram illustrating an example of the configuration of an edge enhancement region detection portion for a case where a tenth edge enhancement region detection method is employed.

FIG. 23 is a diagram illustrating an example of the positional relationship between isolated point pixels and temporary isolated point pixels.

FIG. 24 is a diagram illustrating an example of the configuration of an edge enhancement region detection portion for a case where an eleventh edge enhancement region detection method is employed.

### DESCRIPTION OF THE PREFERRED EMBODIMENTS

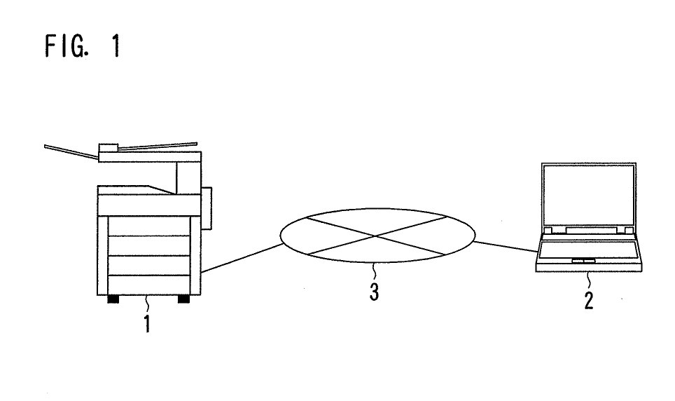

FIG. 1 is a diagram illustrating an example of a network system including an image forming apparatus 1, and

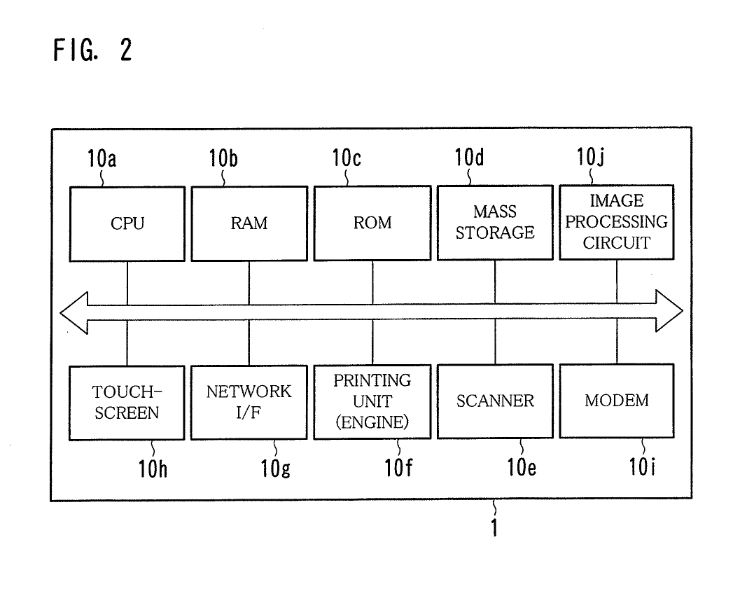

FIG. 2 is a diagram illustrating an example of the hardware configuration of the image forming apparatus 1.

The image forming apparatus 1 shown in FIG. 1 is an apparatus generally called a multifunction device, a Multi-Function Peripheral (MFP), or the like. The image forming apparatus 1 is configured to integrate, thereinto, a variety of functions, such as copying, network printing (PC printing), faxing, and scanning.

The image forming apparatus 1 is capable of sending and receiving image data with a device such as a personal computer 2 via a communication line 3, e.g., a Local Area Network (LAN), a public line, or the Internet.

Referring to FIG. 2, the image forming apparatus 1 is configured of a Central Processing Unit (CPU) 10a, a Random Access Memory (RAM) 10b, a Read-Only Memory (ROM) 10c, a mass storage 10d, a scanner 10e, a printing unit 10f, a network interface 10g, a touchscreen 10h, a modem 10i, an image processing circuit 10j, and so on.

The scanner 10e is a device that reads images printed on paper, such as photographs, characters, drawings, diagrams, and the like, and creates image data thereof.

The touchscreen 10h displays, for example, a screen for giving a message or instructions to a user, a screen for the user to enter a process command and process conditions, and a screen displaying the result of a process performed by the CPU 10a. The touchscreen 10h also detects a position thereof touched by the user with his/her finger, and sends a signal indicating the result of the detection to the CPU 10a.

The network interface log is a Network Interface Card (NIC) for communicating with another device such as a personal computer via the communication line 3.

The modem 101 is a device for transmitting image data via a fixed-line telephone network to another facsimile terminal and vice versa based on a protocol such as Group 3 (G3).

The image processing circuit 10j serves to perform so-called edge enhancement processing based on image data transmitted from the personal computer 2. This will be described later.

The printing unit 10f serves to print, onto paper, an image obtained by scanning with the scanner 10e or an image that has undergone the edge enhancement processing by the image processing circuit 10j.

The ROM 10c and the mass storage 10d store, therein, Operating System (OS) and programs such as firmware or application. These programs are loaded into the RAM 10b as necessary, and executed by the CPU 10a. An example of the mass storage 10d is a hard disk or a flash memory.

The whole or a part of the functions of the image processing circuit 10j may be implemented by causing the CPU 10a to execute programs. In such a case, programs in which steps of the processes mentioned later are described are prepared and the CPU 10a executes the programs.

Detailed descriptions are given below of the configuration of the image processing circuit 10j and edge enhancement processing by the image processing circuit 10j.

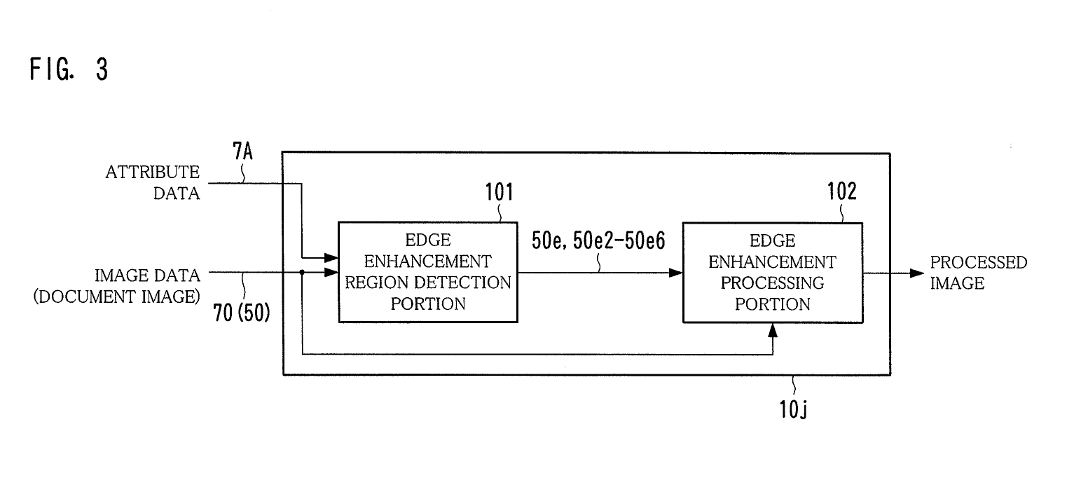

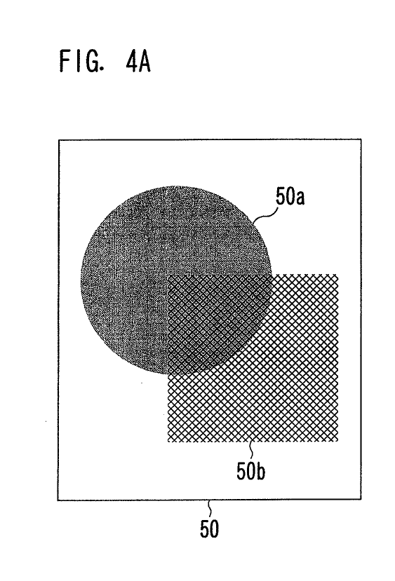

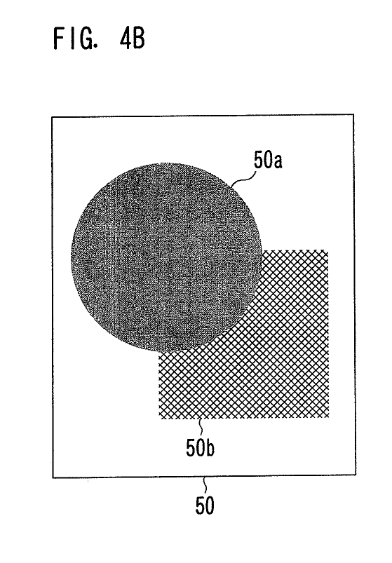

FIG. 3 is a diagram illustrating an example of the configuration of the image processing circuit 10j, and FIGS. 4A and 4B are diagrams illustrating an example of the positional relationship between a translucent image 50a and a rear image 50b both of which are contained in a document image 50.

Referring to FIG. 3, the image processing circuit 10j is configured of an edge enhancement region detection portion 101, an edge enhancement processing portion 102, and so on.

The image processing circuit 10j performs edge enhancement processing on an image reproduced based on image data 70 transmitted from the personal computer 2. The image thus reproduced is hereinafter referred to as a “document image 50”.

The “edge enhancement processing” is processing to enhance the contour of an object such as a character, diagram, or illustration contained in the document image 50, i.e., to enhance an edge of such an object.

The “translucent image” has properties which allow another object image placed in the rear thereof to be visible through the translucent image itself. Referring to FIG. 4A, for example, the translucent image 50a having a circular shape is placed in the foreground as compared to the rear image 50b having a rectangular shape. A part of the rear image 50b overlapping the translucent image 50a is seen through the translucent image 50a. The higher the transmissivity of the translucent image 50a is, the more the rear image 50b is visible therethrough. In the case where the transmissivity of the translucent image 50a is 0%, the part of the rear image 50b overlapping the translucent image 50a is completely hid, and therefore, the part is invisible as exemplified in FIG. 4B. The embodiment describes an example in which the rear image 50b is not a translucent image, i.e., is a non-translucent image.

The edge enhancement region detection portion 101 is operable to detect a region of the translucent image 50a on which edge enhancement processing is to be performed. The region is hereinafter referred to as an “edge enhancement region 50e”.

The edge enhancement processing portion 102 performs edge enhancement processing on the edge enhancement region 50e detected by the edge enhancement region detection portion 101 by, for example, increasing the density of the edge enhancement region 50e.

Further detailed descriptions of the edge enhancement region detection portion 101 are given below. The following eleven methods are taken as examples of a method for detecting the edge enhancement region 50e.

[First Edge Enhancement Region Detection Method]

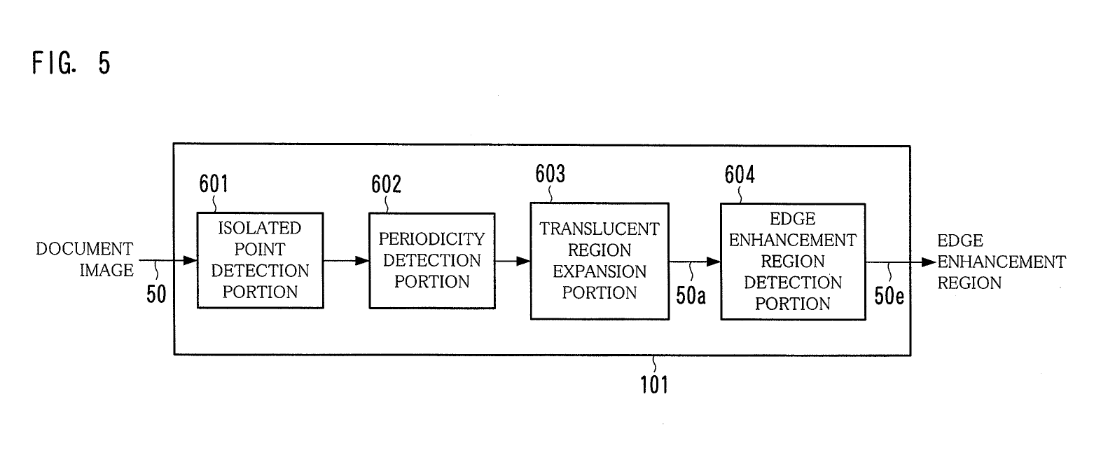

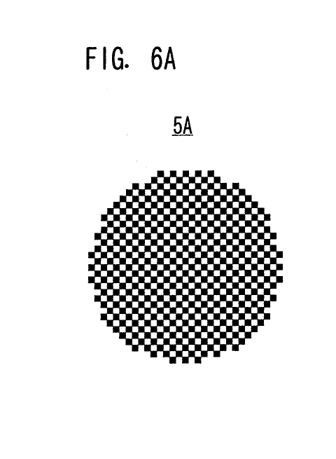

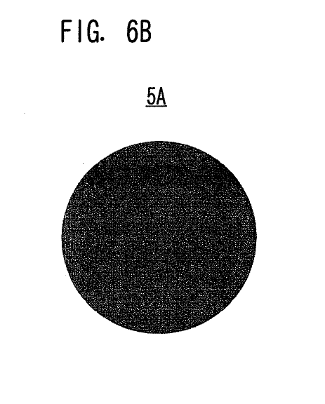

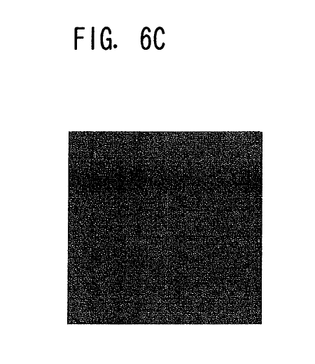

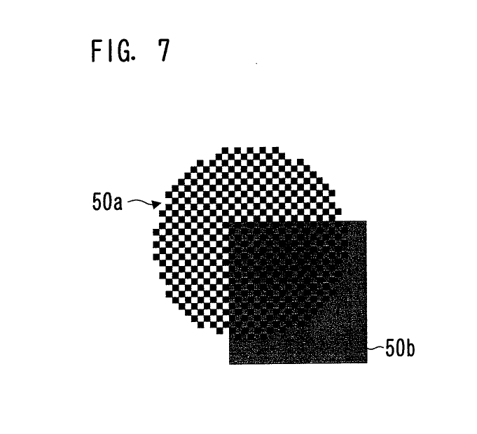

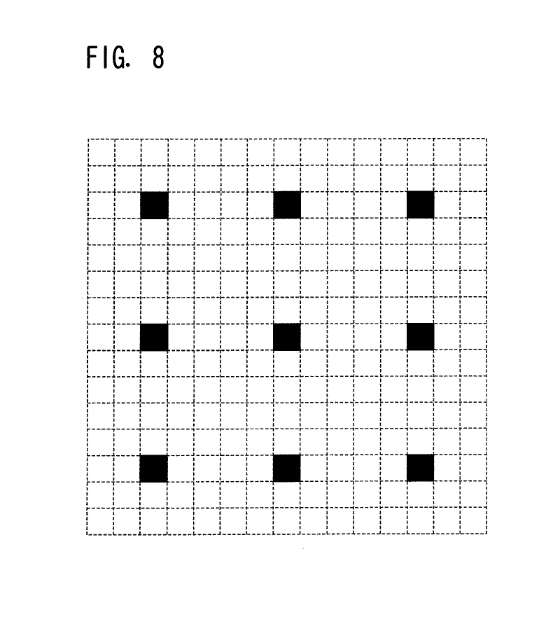

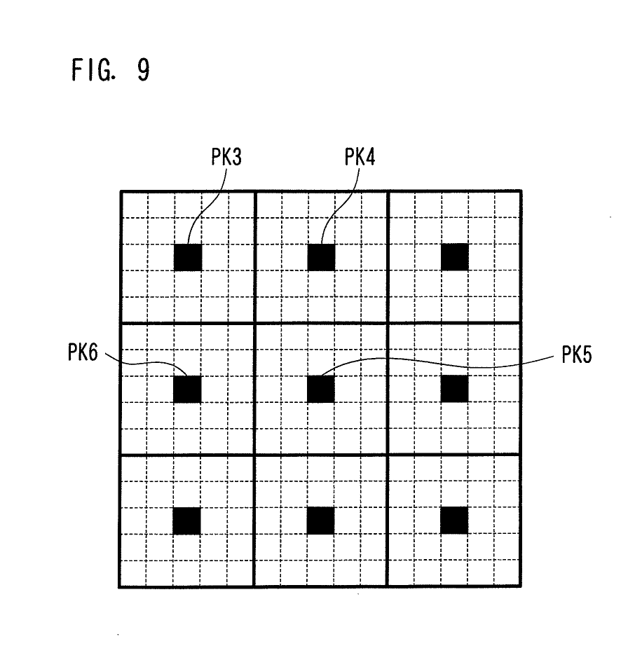

FIG. 5 is a diagram illustrating an example of the configuration of the edge enhancement region detection portion 101 for a case where the first edge enhancement region detection method is employed; FIGS. 6A to 6C are diagrams illustrating an example of attribute images 5A in which attributes of the translucent image 50a are shown; FIG. 7 is a diagram illustrating an example as to how the translucent image 50a and the rear image 50b overlap with each other in pixels; FIG. 8 is a diagram illustrating an example as to how isolated point pixels and non-isolated point pixels are disposed; and FIG. 9 is a diagram illustrating an example of the ranges of isolated point pixels after expansion.

Referring to FIG. 5, according to the first edge enhancement region detection method, the edge enhancement region detection portion 101 is configured of an isolated point detection portion 601, a periodicity detection portion 602, a translucent region expansion portion 603, an edge enhancement region detection portion 604, and so on.

In general, even if a translucent image is displayed, as shown in FIG. 6B, on the personal computer 2 in such a manner that all the pixels have a constant density, the image is converted for printing, as shown in FIG. 6A, in such a manner to include pixels having a constant density and pixels having no constant density. The density is represented by a black square in the illustrated example. A pixel having a constant density is called an “isolated point pixel” because it seems to be an isolated dot. A pixel having no constant density is called a “non-isolated point pixel”.

An image corresponding to an isolated point pixel is printed at a predetermined density. As for a non-isolated point pixel, if no other image is placed in the rear of the translucent image, then nothing is printed at a part corresponding to the non-isolated point pixel. On the other hand, if another image is placed in the rear of the translucent image, then a part corresponding to a pixel of the other image whose position is the same as that of the non-isolated point pixel of the translucent image is printed. In this way, as shown in FIG. 7, parts corresponding to pixels of the rear image 50b whose positions are the same as those of the non-isolated point pixels of the translucent image 50a are printed. This allows a part of the rear image 50b overlapping the translucent image 50a to be printed in such a manner to be visible through the translucent image 50a. The higher the transmissivity of the translucent image 50a is, the less an isolated point pixel is likely to appear.

Referring to FIG. 5, the isolated point detection portion 601 is operable to detect an isolated point pixel in the document image 50 reproduced based on the image data 70.

Meanwhile, isolated point pixels of a translucent image are usually arranged at regular intervals. Stated differently, the translucent image is seen with a periodicity (constant pattern).

The periodicity detection portion 602 is operable to detect a periodicity (constant pattern) with which the isolated point pixels detected by the isolated point detection portion 601 appear. A document image 50 is taken as an example, in which isolated point pixels and non-isolated point pixels are disposed as shown in FIG. 8. In such a case, the periodicity detection portion 602 detects the appearance of an isolated point pixel at a rate (interval) of one per five pixels in each of the X-axis direction and the Y-axis direction of the document image 50 of FIG. 8.

The translucent region expansion portion 603 performs expansion (dilation) processing on a region corresponding to the isolated point pixels whose periodicity of appearance is detected by the periodicity detection portion 602; thereby to detect a region of the translucent image 50a. To be specific, the translucent region expansion portion 603 expands the individual isolated point pixels whose periodicity of appearance has been detected in such a manner to bring the isolated point pixels into contact with one another. Thereby, each of the isolated point pixels shown in FIG. 8 is expanded to a region defined by 5×5 pixels denoted by a thick line of FIG. 9.

The translucent region expansion portion 603, then, detects a set of all the post-expansion regions as a region of the translucent image 50a.

The edge enhancement region detection portion 604 detects, as an edge enhancement region 50e, an edge (contour) having a predetermined width of the region of the translucent image 50a detected by the translucent region expansion portion 603.

[Second Edge Enhancement Region Detection Method]

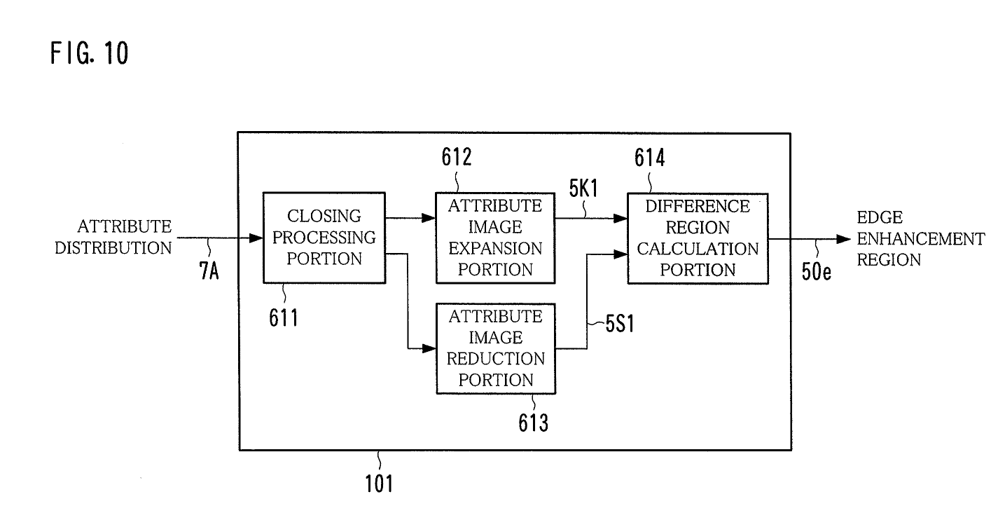

FIG. 10 is a diagram illustrating an example of the configuration of the edge enhancement region detection portion 101 for a case where the second edge enhancement region detection method is employed.

As shown in FIG. 3, the edge enhancement region detection portion 101 receives, from the personal computer 2, an input of attribute data 7A together with image data 70.

The attribute data 7A is data indicating attributes of the translucent image 50a. The attribute data 7A is 1-bit data or 2-bit data indicating the type of a region such as a “character region” and a “photograph region”, namely, indicating region information. The attribute data 7A indicates region information for each pixel of the translucent image 50a in some cases, and indicates region information for the entire translucent image 50a in other cases. With the former case, 1-bit data or 2-bit data indicating region information is prepared on a pixel-by-pixel basis, and a set of such data serves as the attribute data 7A.

The second edge enhancement region detection method is used for a case where the translucent image 50a in the document image 50 reproduced based on the inputted image data 70 is constituted by isolated point pixels and non-isolated point pixels as shown in FIG. 6A. In such a case, a rough region of the translucent image 50a is known; however an edge of the translucent image 50a is undetermined.

Referring to FIG. 10, according to the second edge enhancement region detection method, the edge enhancement region detection portion 101 is configured of a closing processing portion 611, an attribute image expansion portion 612, an attribute image reduction portion 613, a difference region calculation portion 614, and so on.

The closing processing portion 611 performs closing processing on an image showing the distribution of pixels having at least a constant density in the translucent image 50a. Such an image to undergo the closing processing is hereinafter referred to as an “attribute image 5A”. Stated differently, the closing processing portion 611 performs processing for expanding (dilating) or scaling down (eroding) the individual dots. In the attribute image 5A, a pixel having at least a constant density is denoted by a black dot, while a pixel having a density less than the constant density is denoted by a white dot. As for the case of FIG. 6A, the attribute image 5A and the document image 50 have substantially the same pattern as each other.

The attribute image expansion portion 612 expands the range of the attribute image 5A that has undergone the closing processing by an amount corresponding to a predetermined number of pixels; thereby to obtain an expanded region 5K1.

The attribute image reduction portion 613 reduces the range of the attribute image 5A that has undergone the closing processing by an amount corresponding to a predetermined number of pixels; thereby to obtain a reduced region 5S1.

The difference region calculation portion 614 calculates a region defined by the difference between the expanded region 5K1 and the reduced region 551. Stated differently, the difference region calculation portion 614 obtains a difference region by removing the reduced region 551 from the expanded region 5K1. The region obtained in this way is an edge enhancement region 50e of the translucent image 50a.

[Third Edge Enhancement Region Detection Method]

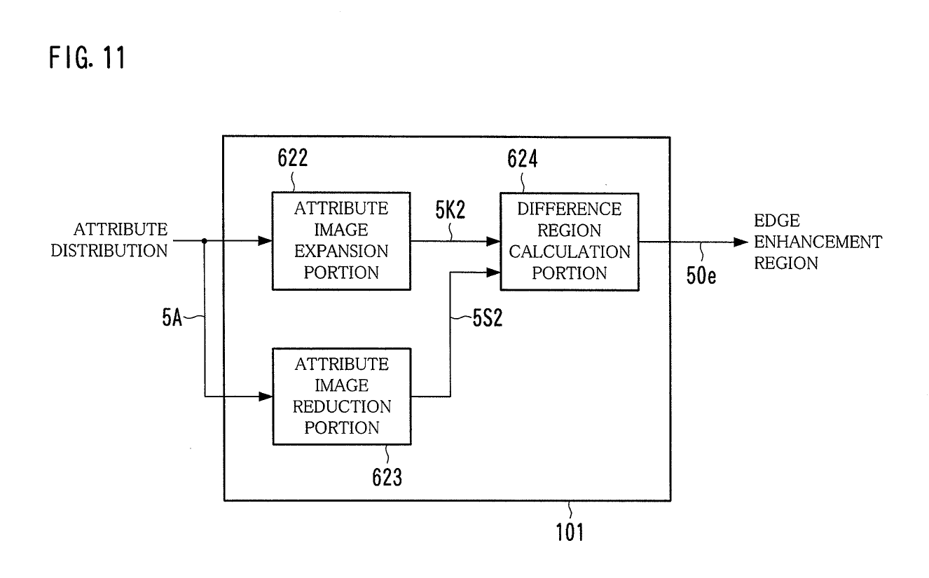

FIG. 11 is a diagram illustrating an example of the configuration of the edge enhancement region detection portion 101 for a case where the third edge enhancement region detection method is employed.

The third edge enhancement region detection method is used for a case where the attribute data 7A indicates that the translucent image 50a in the document image 50 reproduced based on the inputted image data 70 has all pixels having a constant density, as shown in FIG. 6B. In such a case, unlike the case of FIG. 6A, an edge of the translucent image 50a is clear.

Referring to FIG. 11, according to the third edge enhancement region detection method, the edge enhancement region detection portion 101 is configured of an attribute image expansion portion 622, an attribute image reduction portion 623, a difference region calculation portion 624, and so on.

According to the attribute data 7A, the region of the translucent image 50a, particularly, the edge thereof is specified as shown in FIG. 6B. Thus, it is not necessary to perform closing processing on the attribute image 5A in the third edge enhancement region detection method.

The attribute image expansion portion 622 expands the range of the attribute image 5A by an amount corresponding to a predetermined number of pixels; thereby to obtain an expanded region 5K2.

The attribute image reduction portion 623 reduces the range of the attribute image 5A by an amount corresponding to a predetermined number of pixels; thereby to obtain a reduced region 5S2.

As with the case of the difference region calculation portion 614 of FIG. 10, the difference region calculation portion 624 calculates a region defined by the difference between the expanded region 5K2 and the reduced region 5S2. Stated differently, the difference region calculation portion 624 obtains a difference region by removing the reduced region 5S2 from the expanded region 5K2. The region obtained in this way is an edge enhancement region 50e of the translucent image 50a.

[Fourth Edge Enhancement Region Detection Method]

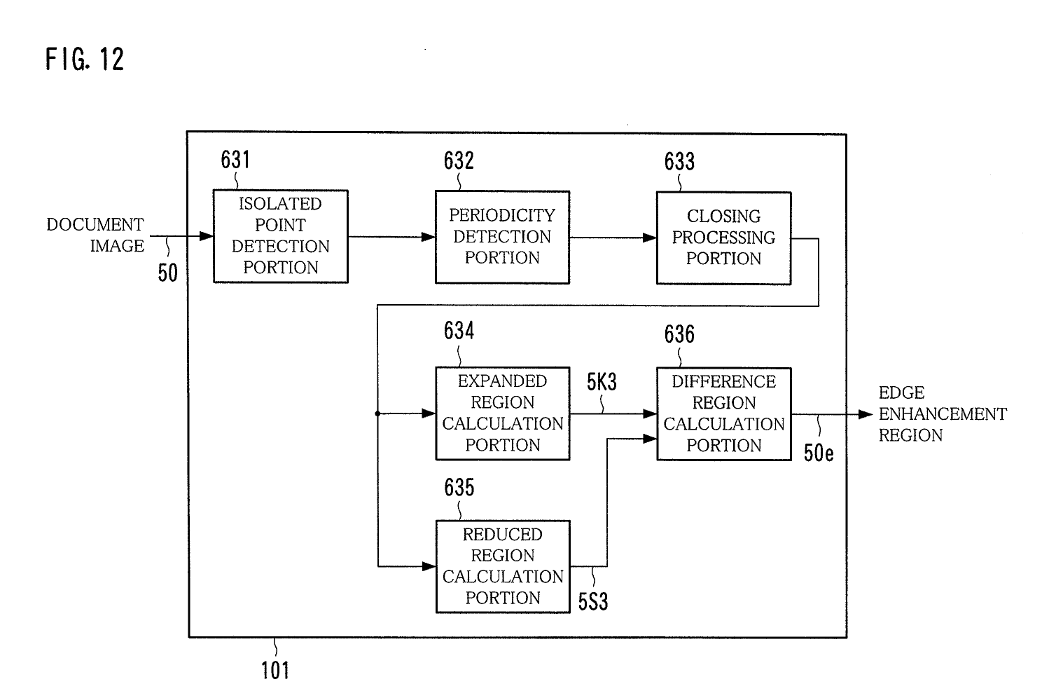

FIG. 12 is a diagram illustrating an example of the configuration of the edge enhancement region detection portion 101 for a case where the fourth edge enhancement region detection method is employed.

The fourth edge enhancement region detection method is used for a case where the pattern of the translucent image 50a in the document image 50 reproduced based on the inputted image data 70 is not identical with that of the attribute image 5A reproduced based on the attribute data 7A. In short, the fourth edge enhancement region detection method is used for a case where the attribute image 5A does not correspond to any of the patterns shown in FIGS. 6A and 6B, e.g., for a case where the attribute image 5A corresponds to the pattern shown in FIG. 6C.

Referring to FIG. 12, according to the fourth edge enhancement region detection method, the edge enhancement region detection portion 101 is configured of an isolated point detection portion 631, a periodicity detection portion 632, a closing processing portion 633, an expanded region calculation portion 634, a reduced region calculation portion 635, a difference region calculation portion 636, and so on.

The isolated point detection portion 631 is operable to detect an isolated point pixel in the document image 50 reproduced based on the image data 70.

The periodicity detection portion 632 is operable to detect a periodicity (constant pattern) with which the isolated point pixels detected by the isolated point detection portion 631 appear. The periodicity detection portion 632, then, detects a set of isolated point pixels for which a periodicity is observed.

The closing processing portion 633 performs closing processing on a region containing the set of isolated point pixels for which a periodicity is observed, e.g., a rectangular region within which such isolated point pixels fall.

The expanded region calculation portion 634 expands an image that has undergone the closing processing by an amount corresponding to a predetermined number of pixels; thereby to obtain an expanded region 5K3.

The reduced region calculation portion 635 reduces an image that has undergone the closing processing by an amount corresponding to a predetermined number of pixels; thereby to obtain a reduced region 5S3.

As with the difference region calculation portion 614 of FIG. 10 and the difference region calculation portion 624 of FIG. 11, the difference region calculation portion 636 calculates a region defined by the difference between the expanded region 5K3 and the reduced region 5S3. Stated differently, the difference region calculation portion 636 obtains a difference region by removing the reduced region 5S3 from the expanded region 5K3. The region obtained in this way is an edge enhancement region 50e of the translucent image 50a.

[Fifth Edge Enhancement Region Detection Method]

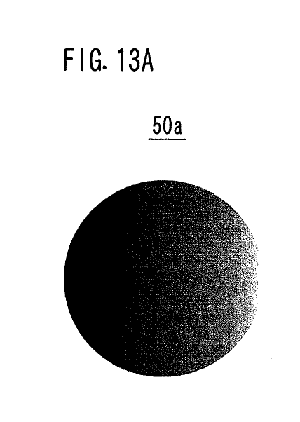

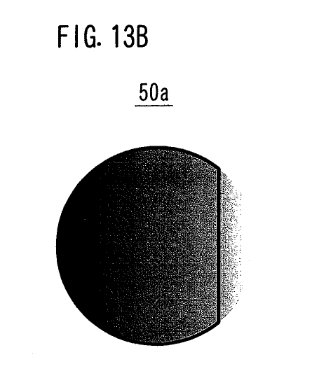

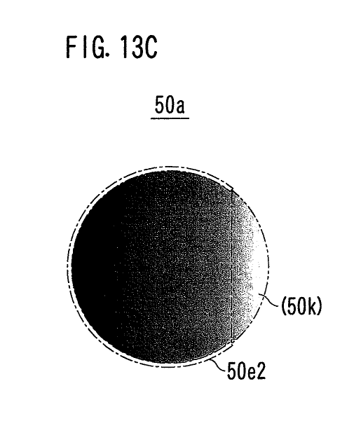

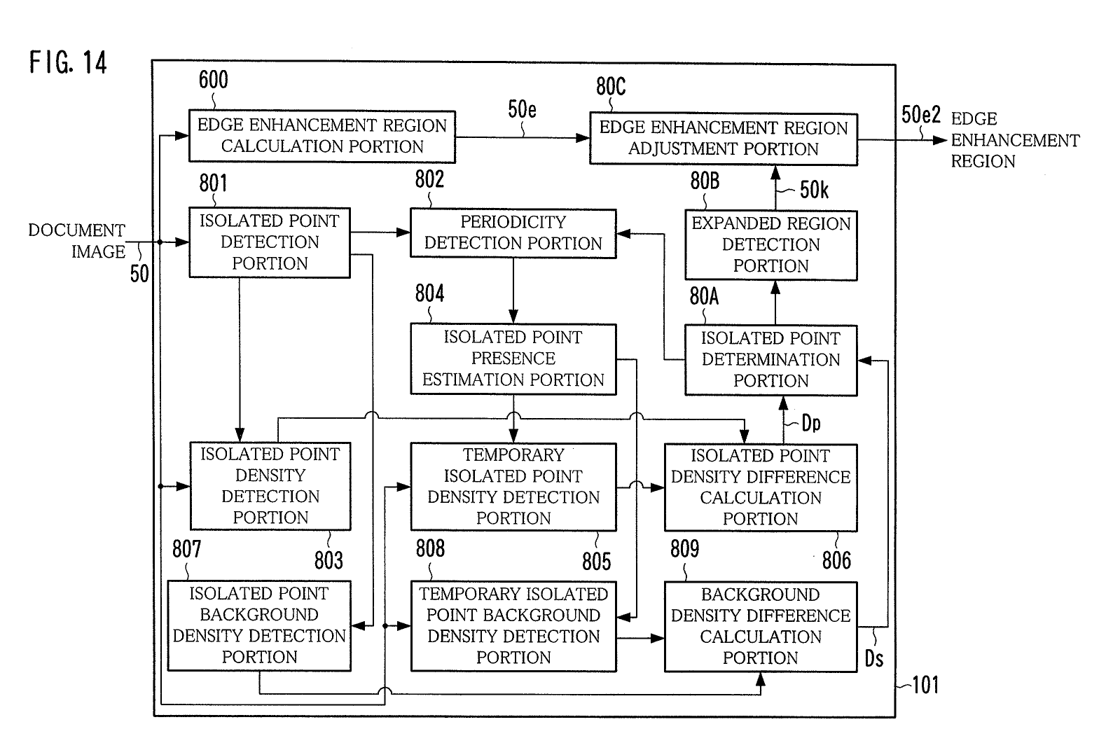

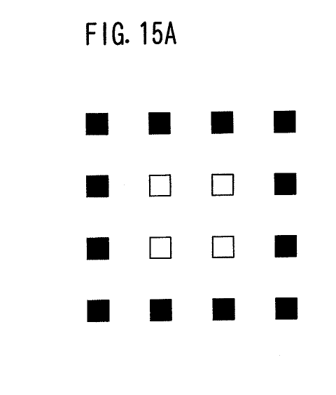

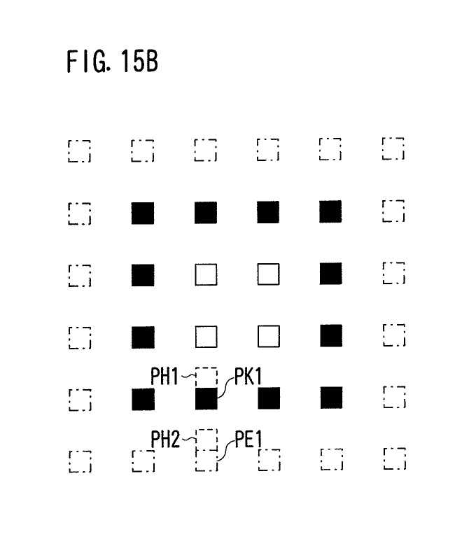

FIGS. 13A to 13C are diagrams illustrating an example of the translucent image 50a expressed in gradations; FIG. 14 is a diagram illustrating an example of the configuration of the edge enhancement region detection portion 101 for a case where the fifth edge enhancement region detection method is employed; and FIGS. 15A and 15B are diagrams illustrating an example of the positional relationship among isolated point pixels, temporary isolated point pixels, and non-isolated point pixels.

As with the case of the fourth edge enhancement region detection method, the fifth edge enhancement region detection method is used suitably for a case where the pattern of the translucent image 50a in the document image 50 reproduced based on the inputted image data 70 does not correspond to any of the patterns shown in FIGS. 6A and 6B.

In the case where a translucent image 50a is represented in gradations from a specific color (black, for example) to white as shown in FIG. 13A, an isolated point pixel having a low density may not be detected because the difference in density between the isolated point pixel and a non-isolated point pixel adjacent thereto is not sufficient for the detection. Accordingly, edge enhancement processing on the translucent image 50a probably causes a non-edge part to be enhanced as shown in FIG. 13B.

To cope with this, even if the translucent image 50a is expressed in gradations, the edge enhancement region detection portion 101 uses the fifth edge enhancement region detection method to detect the edge enhancement region 50e as shown in FIG. 13C more accurately than with the conventional methods.

According to the fifth edge enhancement region detection method, the edge enhancement region detection portion 101 is configured of the modules of the isolated point detection portion 601 through the edge enhancement region detection portion 604 as shown in FIG. 5. Instead of these modules, the edge enhancement region detection portion 101 may be configured of the modules of the closing processing portion 611 through the difference region calculation portion 614 as shown in FIG. 10. Alternatively, the edge enhancement region detection portion 101 may be configured of the modules of the attribute image expansion portion 622 through the difference region calculation portion 624 as shown in FIG. 11. Yet alternatively, the edge enhancement region detection portion 101 may be configured of the modules of the isolated point detection portion 631 through the difference region calculation portion 636 as shown in FIG. 12.

In short, the edge enhancement region detection portion 101 is provided with means for determining the edge enhancement region 50e by employing any of the first through fifth edge enhancement region detection methods. Such means for determining the edge enhancement region 50e are hereinafter referred to as an “edge enhancement region calculation portion 600”.

As shown in FIG. 14, the edge enhancement region detection portion 101 further includes an isolated point detection portion 801, a periodicity detection portion 802, an isolated point density detection portion 803, an isolated point presence estimation portion 804, a temporary isolated point density detection portion 805, an isolated point density difference calculation portion 806, an isolated point background density detection portion 807, a temporary isolated point background density detection portion 808, a background density difference calculation portion 809, an isolated point determination portion 80A, an expanded region detection portion 80B, and an edge enhancement region adjustment portion 80C.

The isolated point detection portion 801 is operable to detect an isolated point pixel in the document image 50 reproduced based on the image data 70.

The periodicity detection portion 802 is operable to detect a periodicity with which the isolated point pixels detected by the isolated point detection portion 801 appear.

The isolated point density detection portion 803 detects a density of each of the isolated point pixels detected by the isolated point detection portion 801.

The isolated point presence estimation portion 804 is operable to find a pixel that has not been detected by the isolated point detection portion 801, but is likely to be an isolated point pixel based on the detection results by the isolated point detection portion 801 and the periodicity detection portion 802.

To be specific, the isolated point presence estimation portion 804 selects, from among the isolated point pixels for which a periodicity has been detected by the periodicity detection portion 802, an isolated point pixel placed at a position corresponding to the end of the periodicity. The isolated point presence estimation portion 804, then, finds out pixels which would serve as isolated point pixels if another periodicity were observed, and assumes that the pixels thus found out are likely to be isolated point pixels.

In the case, for example, where 4×4 isolated point pixels are detected as shown in FIG. 15A, the isolated point presence estimation portion 804 assumes that twenty pixels which are denoted by dot-dash lines in FIG. 15B and disposed around twelve blacken isolated point pixels are likely to be isolated point pixels.

The temporary isolated point density detection portion 805 detects a density of each of the pixels that have been presumed to be potential isolated point pixels by the isolated point presence estimation portion 804. Such a potential isolated point pixel is hereinafter referred to as a “temporary isolated point pixel”.

The isolated point density difference calculation portion 806 calculates a difference Dp in density between each of the temporary isolated point pixels and an isolated point pixel closest to the temporary isolated point pixel. As for a temporary isolated point pixel PE1 shown in FIG. 15B, for example, the isolated point density difference calculation portion 806 calculates a difference Dp in density between the temporary isolated point pixel PE1 and an isolated point pixel PK1.

The isolated point background density detection portion 807 detects, as a density of the base, a density of any one of non-isolated point pixels adjacent to the individual isolated point pixels. As for the isolated point pixel PK1 shown in FIG. 15B, for example, the isolated point background density detection portion 807 detects, as a density of the base, a density of a non-isolated point pixel PH1 that is adjacent to the isolated point pixel PK1 and is denoted by a dotted line.

The temporary isolated point background density detection portion 808 detects, as a density of the base, a density of any one of non-isolated point pixels adjacent to the individual temporary isolated point pixels. As for the temporary isolated point pixel PE1 shown in FIG. 15B, for example, the temporary isolated point background density detection portion 808 detects, as a density of the base, a density of a non-isolated point pixel PH2 that is adjacent to the temporary isolated point pixel PE1 and is denoted by a dotted line.

The background density difference calculation portion 809 calculates a difference Ds in density between the base of each of the temporary isolated point pixels and the base of an isolated point pixel closest to the temporary isolated point pixel. As for the temporary isolated point pixel PE1 shown in FIG. 15B, for example, the background density difference calculation portion 809 detects, as the difference Ds, a difference between a density of the base of the temporary isolated point pixel PE1, i.e., a density the non-isolated point pixel PH2, and a density of the base of the isolated point pixel PK1, i.e., a density of the non-isolated point pixel PH1.

The isolated point determination portion 80A determines whether or not each of the temporary isolated point pixels is an isolated point pixel. The following is a description of a method for the determination by taking an example of the temporary isolated point pixel PE1 shown in FIG. 15B.

The isolated point determination portion 80A determines whether or not a difference Dp in density between the temporary isolated point pixel PE1 and an isolated point pixel closest thereto, namely, the isolated point pixel PK1, exceeds a threshold α1. Such a threshold α1 is 10, for example, in the case of 256 gray levels. Further, the isolated point determination portion 80A determines whether or not a difference Ds in density between the base of the temporary isolated point pixel PE1 and the base of the isolated point pixel PK1 is equal to or smaller than a predetermined threshold α2. Such a threshold α2 is 2, for example, in the case of 256 gray levels.

If the difference Dp exceeds the threshold α1, and at the same time, if the difference Ds is equal to or smaller than the threshold α2, then the isolated point determination portion 80A determines that the temporary isolated point pixel PE1 is an isolated point pixel. Otherwise, the isolated point determination portion 80A determines that the temporary isolated point pixel PE1 is a non-isolated point pixel.

Stated differently, if a certain level of change is observed between a density of the isolated point pixel PK1 and a density of the temporary isolated point pixel PE1, and at the same time, if little or no change is observed between a density of the base of the isolated point pixel PK1 and a density of the base of the temporary isolated point pixel PE1, then the isolated point determination portion 80A determines that the temporary isolated point pixel PE1 is an isolated point pixel.

If the temporary isolated point pixel PE1 is determined to be an isolated point pixel, one or more other isolated point pixels of the translucent image 50a may be included in pixels that have not yet been subjected to the processing by the isolated point presence estimation portion 804.

In view of this, in the case where the isolated point determination portion 80A determines that a certain pixel is an isolated point pixel, the isolated point density detection portion 803 through the isolated point determination portion 80A described earlier regard the pixel as one of isolated pixels for which a periodicity has been detected, and perform the processing discussed above again on the pixel. Then, the processing discussed above is repeated until no more new isolated point pixels are found by the isolated point determination portion 80A.

The isolated point pixels detected or determined in the document image 50 in this way are isolated point pixels of the translucent image 50a.

A region of the temporary isolated point pixels determined to be isolated point pixels by the isolated point determination portion 80A is originally a part of the translucent image 50a even if such a region is not been detected to be a part of the translucent image 50a by the edge enhancement region calculation portion 600.

In view of this, the expanded region detection portion 80B uses closing processing and so on, to detect, as an expanded region 50k, the region of the temporary isolated point pixels determined to be isolated point pixels by the isolated point determination portion 80A.

The edge enhancement region adjustment portion 80C adjusts the edge enhancement region 50e obtained by the edge enhancement region calculation portion 600 by removing a part of the edge enhancement region 50e overlapping the expanded region 50k detected by the expanded region detection portion 80B. Hereinafter, an edge enhancement region 50e obtained as a result of the removal of a part thereof overlapping the expanded region 50k is referred to as an “edge enhancement region 50e2”.

[Sixth Edge Enhancement Region Detection Method]

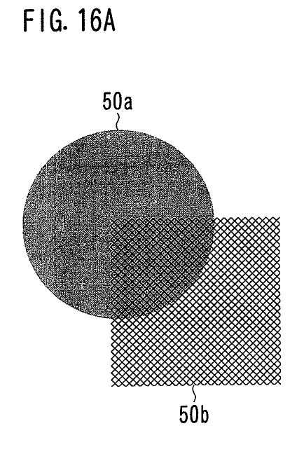

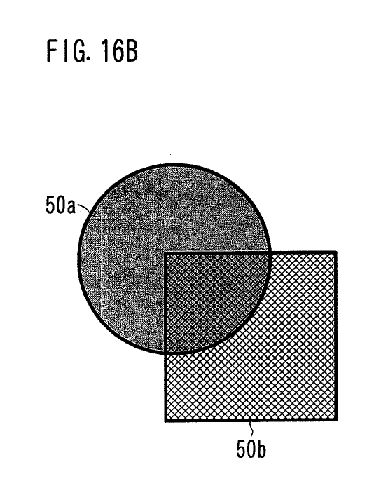

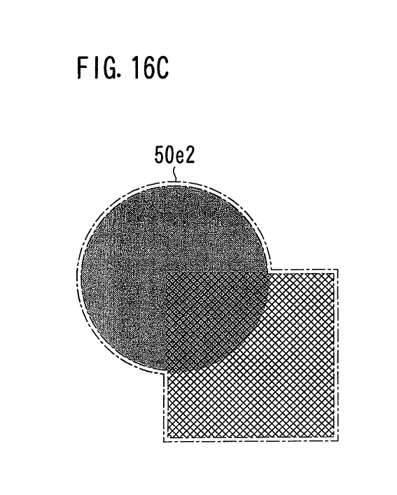

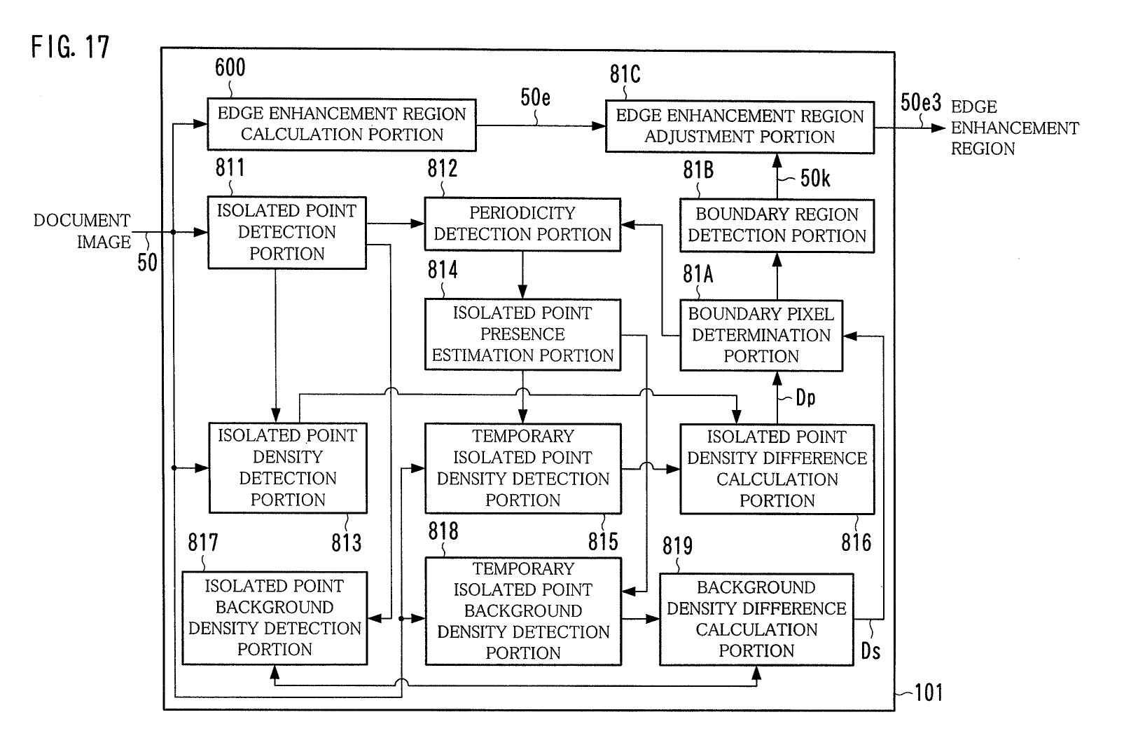

FIGS. 16A to 16C are diagrams illustrating an example of the positional relationship among the translucent image 50a, the rear image 50b, and the edge enhancement region 50e2; and FIG. 17 is a diagram illustrating an example of the configuration of the edge enhancement region detection portion 101 for a case where the sixth edge enhancement region detection method is employed.

As with the cases of the fourth and fifth edge enhancement region detection methods, the sixth edge enhancement region detection method is suitably used for a case where the pattern of the translucent image 50a in the document image 50 reproduced based on the inputted image data 70 does not correspond to any of the patterns shown in FIGS. 6A and 6B.

In the case where edge enhancement processing is performed on the entire document image 50 with the rear image 50b placed in the back of the translucent image 50a as shown in FIG. 16A, an edge is sometimes enhanced, as shown in FIG. 16B, in such a manner to surround a part at which the translucent image 50a and the rear image 50b overlap with each other. This is because, in the overlapping part, densities of non-isolated point pixels around isolated point pixels are high. As a result, a density difference enough to detect an isolated point pixel is not observed between the isolated point pixels and the non-isolated point pixels.

It is desirable that, as shown in FIG. 16C, the boundary between the translucent image 50a and the rear image 50b be not enhanced.

To cope with this, the edge enhancement region detection portion 101 employs the sixth edge enhancement region detection method to perform edge enhancement processing to prevent the boundary between the translucent image 50a and the rear image 50b from being enhanced.

As with the case of the fifth edge enhancement region detection method, the edge enhancement region detection portion 101 according to the sixth edge enhancement region detection method is provided with, as the edge enhancement region calculation portion 600, any one of the following: a) the modules of the isolated point detection portion 601 through the edge enhancement region detection portion 604 as shown in FIG. 5; b) the modules of the closing processing portion 611 through the difference region calculation portion 614 as shown in FIG. 10; c) the modules of the attribute image expansion portion 622 through the difference region calculation portion 624 as shown in FIG. 11; and d) the modules of the isolated point detection portion 631 through the difference region calculation portion 636 as shown in FIG. 12.

As shown in FIG. 17, the edge enhancement region detection portion 101 further includes an isolated point detection portion 811, a periodicity detection portion 812, an isolated point density detection portion 813, an isolated point presence estimation portion 814, a temporary isolated point density detection portion 815, an isolated point density difference calculation portion 816, an isolated point background density detection portion 817, a temporary isolated point background density detection portion 818, a background density difference calculation portion 819, a boundary pixel determination portion 81A, a boundary region detection portion 81B, and an edge enhancement region adjustment portion 81C.

Processing performed by the isolated point detection portion 811 through the background density difference calculation portion 819 is the same as that by the isolated point detection portion 801 through the background density difference calculation portion 809 shown in FIG. 14.

To be specific, the isolated point detection portion 811 is operable to detect an isolated point pixel in the document image 50 reproduced based on the image data 70. The periodicity detection portion 812 is operable to detect a periodicity with which the isolated point pixels detected by the isolated point detection portion 811 appear.

The isolated point presence estimation portion 814 is operable to find a pixel that has not been detected by the isolated point detection portion 811, but is likely to be an isolated point pixel based on the detection results by the isolated point detection portion 811 and the periodicity detection portion 812. In short, the isolated point presence estimation portion 814 detects a temporary isolated point pixel.

The isolated point density detection portion 813 detects a density of each of the isolated point pixels detected by the isolated point detection portion 811. The temporary isolated point density detection portion 815 detects a density of each of the temporary isolated point pixels that have been detected by the isolated point presence estimation portion 814. The isolated point density difference calculation portion 816 calculates a difference Dp in density between each of the temporary isolated point pixels and an isolated point pixel closest to the temporary isolated point pixel.

The isolated point background density detection portion 817 detects, as a density of the base, a density of any one of non-isolated point pixels adjacent to the individual isolated point pixels. The temporary isolated point background density detection portion 818 detects, as a density of the base, a density of any one of non-isolated point pixels adjacent to the individual temporary isolated point pixels. The background density difference calculation portion 819 calculates a difference Ds in density between the base of each of the temporary isolated point pixels and the base of an isolated point pixel closest to the temporary isolated point pixel.

The boundary pixel determination portion 81A determines whether or not each of the temporary isolated point pixels is disposed around the boundary between the translucent image 50a and the rear image 50b by using the following method.

The boundary pixel determination portion 81A checks whether or not a difference Dp in density between a temporary isolated point pixel and an isolated point pixel closest thereto is equal to or smaller than a threshold α3. Such a threshold α3 is 2, for example, in the case of 256 gray levels. Further, the boundary pixel determination portion 81A checks whether or not a difference Ds in density between the base of the temporary isolated point pixel and the base of the isolated point pixel exceeds a predetermined threshold α4. Such a threshold α4 is 10, for example, in the case of 256 gray levels.

If the difference Dp is equal to or smaller than the threshold α3, and at the same time, if the difference Ds exceeds the threshold α4, then the boundary pixel determination portion 81A determines that the temporary isolated point pixel is disposed around the boundary between the translucent image 50a and the rear image 50b. Otherwise, the boundary pixel determination portion 81A determines that the temporary isolated point pixel is not disposed around the boundary therebetween.

Stated differently, if little change is observed between a density of a temporary isolated point pixel and a density of the preceding isolated point pixel, and at the same time, if a certain level of change is observed between a density of the base of the temporary isolated point pixel and a density of the base of the preceding isolated point pixel, then the boundary pixel determination portion 81A determines that the temporary isolated point pixel is disposed around the boundary between the translucent image 50a and the rear image 50b.

The boundary region detection portion 81B uses closing processing and so on, to detect, as a boundary region 50s, the region corresponding to the temporary isolated point pixel determined to be disposed near the boundary between the translucent image 50a and the rear image 50b by the boundary pixel determination portion 81A.

The edge enhancement region adjustment portion 81C adjusts the edge enhancement region 50e obtained by the edge enhancement region calculation portion 600 by removing a part of the edge enhancement region 50e overlapping the boundary region 50s detected by the boundary region detection portion 81B. Hereinafter, an edge enhancement region 50e obtained as a result of the removal of a part thereof overlapping the boundary region 50s is referred to as an “edge enhancement region 50e3”.

[Seventh Edge Enhancement Region Detection Method]

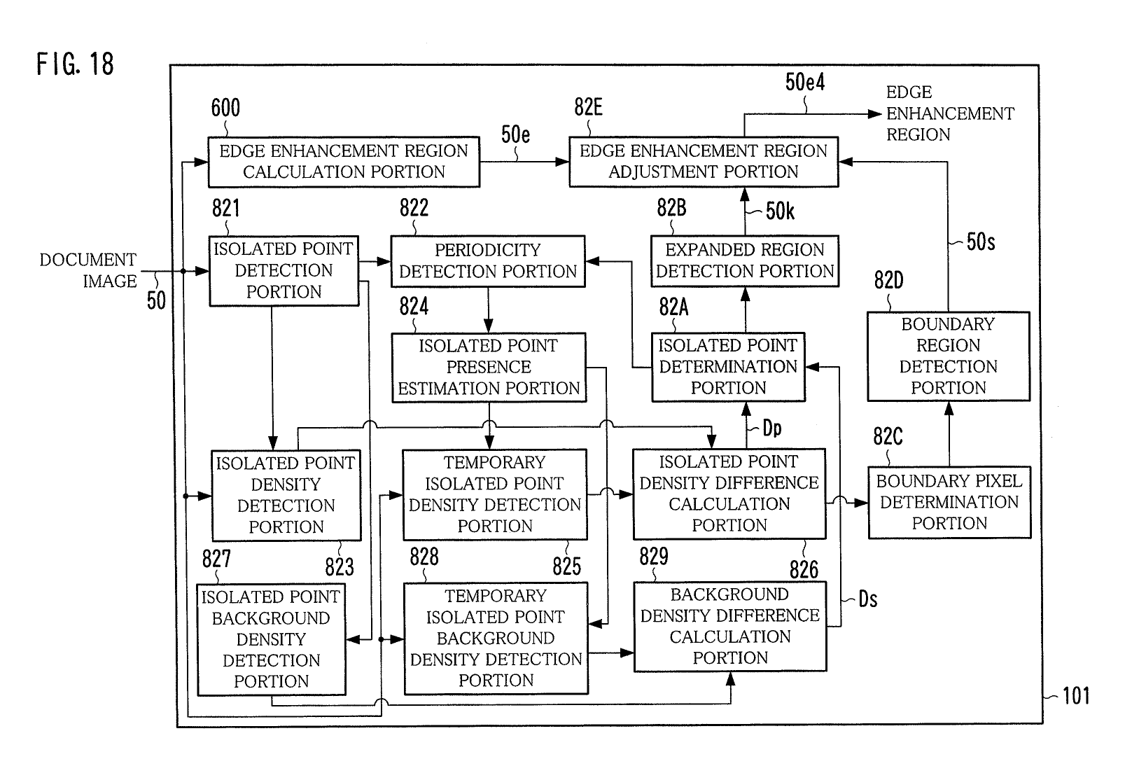

FIG. 18 is a diagram illustrating an example of the configuration of the edge enhancement region detection portion 101 for a case where the seventh edge enhancement region detection method is employed.

As with the cases of the fourth through sixth edge enhancement region detection methods, the seventh edge enhancement region detection method is suitably used for a case where the pattern of the translucent image 50a in the document image 50 reproduced based on the inputted image data 70 does not correspond to any of the patterns shown in FIGS. 6A and 6B.

The seventh edge enhancement region detection method corresponds to the combination of the fifth and sixth edge enhancement region detection methods.

Referring to FIG. 18, in the seventh edge enhancement region detection method, the edge enhancement region detection portion 101 is configured of an edge enhancement region calculation portion 600, an isolated point detection portion 821, a periodicity detection portion 822, an isolated point density detection portion 823, an isolated point presence estimation portion 824, a temporary isolated point density detection portion 825, an isolated point density difference calculation portion 826, an isolated point background density detection portion 827, a temporary isolated point background density detection portion 828, a background density difference calculation portion 829, an isolated point determination portion 82A, an expanded region detection portion 82B, a boundary pixel determination portion 82C, a boundary region detection portion 82D, an edge enhancement region adjustment portion 82E, and so on.

As with the cases of the fifth and sixth edge enhancement region detection methods, the edge enhancement region calculation portion 600 is a module to determine an edge enhancement region 50e by using the first edge enhancement region detection method or the fourth edge enhancement region detection method.

The functions of the isolated point detection portion 821 through the background density difference calculation portion 829 are respectively the same as those of the isolated point detection portion 801 through the background density difference calculation portion 809 (see FIG. 14) according to the fifth edge enhancement region detection method, and, are respectively the same as those of the isolated point detection portion 811 through the background density difference calculation portion 819 (see FIG. 17) according to the sixth edge enhancement region detection method.

The functions of the isolated point determination portion 82A and the expanded area detection portion 82B are respectively the same as those of the isolated point determination portion 80A and the expanded area detection portion 80B according to the fifth edge enhancement region detection method. Thus, the isolated point determination portion 82A and the expanded area detection portion 82B perform processing; thereby to detect the expanded region 50k.

The functions of the boundary pixel determination portion 82C and the boundary region detection portion 82D are respectively the same as those of the boundary pixel determination portion 81A and the boundary region detection portion 81B according to the sixth edge enhancement region detection method. Thus, the boundary pixel determination portion 82C and the boundary region detection portion 82D perform processing; thereby to detect the boundary region 50s.

The edge enhancement region adjustment portion 82E adjusts the edge enhancement region 50e obtained by the edge enhancement region calculation portion 600 by removing a part of the edge enhancement region 50e overlapping at least one of the expanded region 50k and the boundary region 50s. Hereinafter, an edge enhancement region 50e obtained as a result of the removal of a part thereof overlapping the expanded region 50k is referred to as an “edge enhancement region 50e4”.

[Eighth Edge Enhancement Region Detection Method]

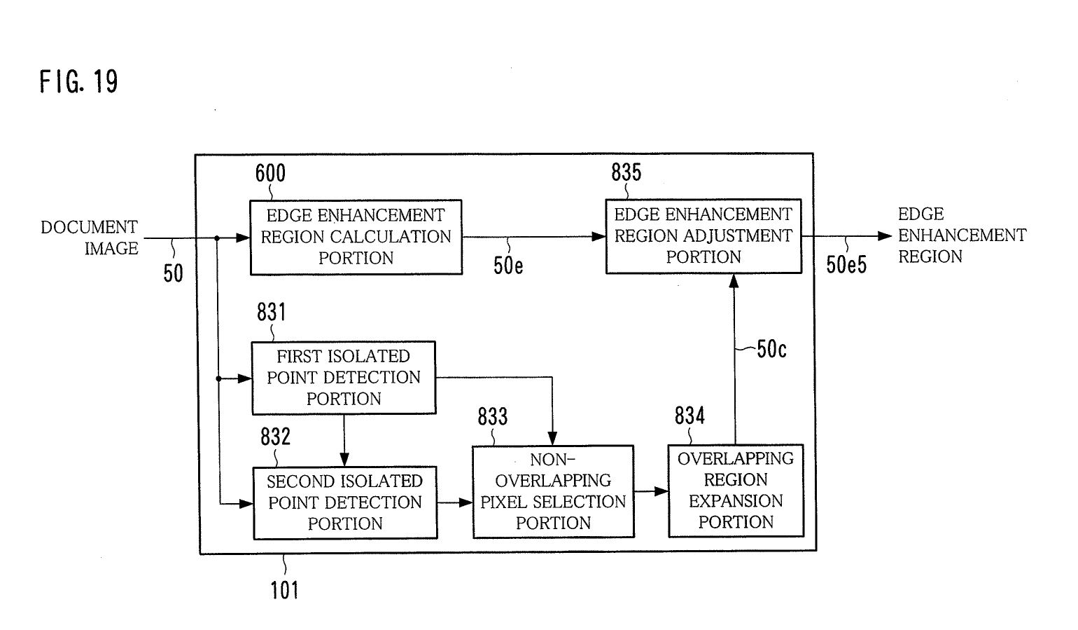

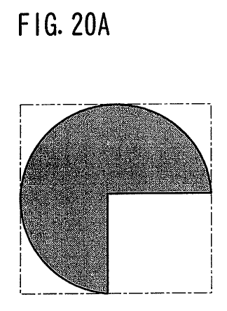

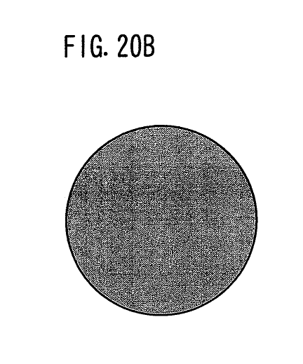

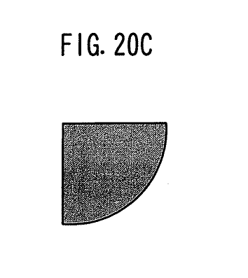

FIG. 19 is a diagram illustrating an example of the configuration of the edge enhancement region detection portion 101 for a case where the eighth edge enhancement region detection method is employed, and FIGS. 20A to 20C are diagrams illustrating an example of regions in which an isolated point pixel is detected.

As with the cases of the fourth through seventh edge enhancement region detection methods, the eighth edge enhancement region detection method is suitably used for a case where the pattern of the translucent image 50a in the document image 50 reproduced based on the inputted image data 70 does not correspond to any of the patterns shown in FIGS. 6A and 6B.

Referring to FIG. 19, in the eighth edge enhancement region detection method, the edge enhancement region detection portion 101 is configured of an edge enhancement region calculation portion 600, a first isolated point detection portion 831, a second isolated point detection portion 832, a non-overlapping pixel selection portion 833, an overlapping region expansion portion 834, an edge enhancement region adjustment portion 835, and so on.

The first isolated point detection portion 831 detects an isolated point pixel in the document image 50. For the detection, the first isolated point detection portion 831 uses a positive threshold γ1. To be specific, the first isolated point detection portion 831 makes an optional pixel as a target. If a density of the target pixel is equal to or greater than the sum of densities of the pixels in its periphery and the threshold γ1, then the first isolated point detection portion 831 detects the target pixel as an isolated point pixel.

The second isolated point detection portion 832 detects an isolated point pixel in a certain region including the isolated point pixel detected by the first isolated point detection portion 831. Note, however, that the second isolated point detection portion 832 uses a positive threshold γ2 smaller than the threshold γ1.

Suppose that, for example, the first isolated point detection portion 831 has detected an isolated point pixel in the region, shown in FIG. 20A, which is a part of the document image 50 shown in FIG. 4A. In such a case, the second isolated point detection portion 832 detects an isolated point pixel in a certain region within which the region shown in FIG. 20A falls, e.g., a rectangular region.

The threshold γ2 used by the second isolated point detection portion 832 is smaller than the threshold γ1 used by the first isolated point detection portion 831. This makes it possible to detect an isolated point pixel that has not been detected by the first isolated point detection portion 831. For example, an isolated point pixel is detected in the region shown in FIG. 20B.

The non-overlapping pixel selection portion 833 selects an isolated point pixel that has not been detected by the first isolated point detection portion 831 and has been detected by the second isolated point detection portion 832. In short, the non-overlapping pixel selection portion 833 selects an isolated point pixel disposed in the region shown in FIG. 20C.

The overlapping region expansion portion 834 performs expansion (dilation) processing on the region of the isolated point pixel selected by the non-overlapping pixel selection portion 833; thereby to detect an overlapping region 50c in which the translucent image 50a and the rear image 50b overlap with each other. In this way, the overlapping region 50c is detected by performing the expansion processing. Accordingly, the overlapping region 50c is slightly larger than a region in which the translucent image 50a and the rear image 50b actually overlap with each other, i.e., the region shown in FIG. 20C.

The edge enhancement region adjustment portion 835 adjusts the edge enhancement region 50e obtained by the edge enhancement region calculation portion 600 by removing a part of the edge enhancement region 50e overlapping the overlapping region 50c detected by the overlapping region expansion portion 834. Hereinafter, an edge enhancement region 50e obtained as a result of the removal of a part thereof overlapping the overlapping region 50c is referred to as an “edge enhancement region 50e5”.

[Ninth Edge Enhancement Region Detection Method]

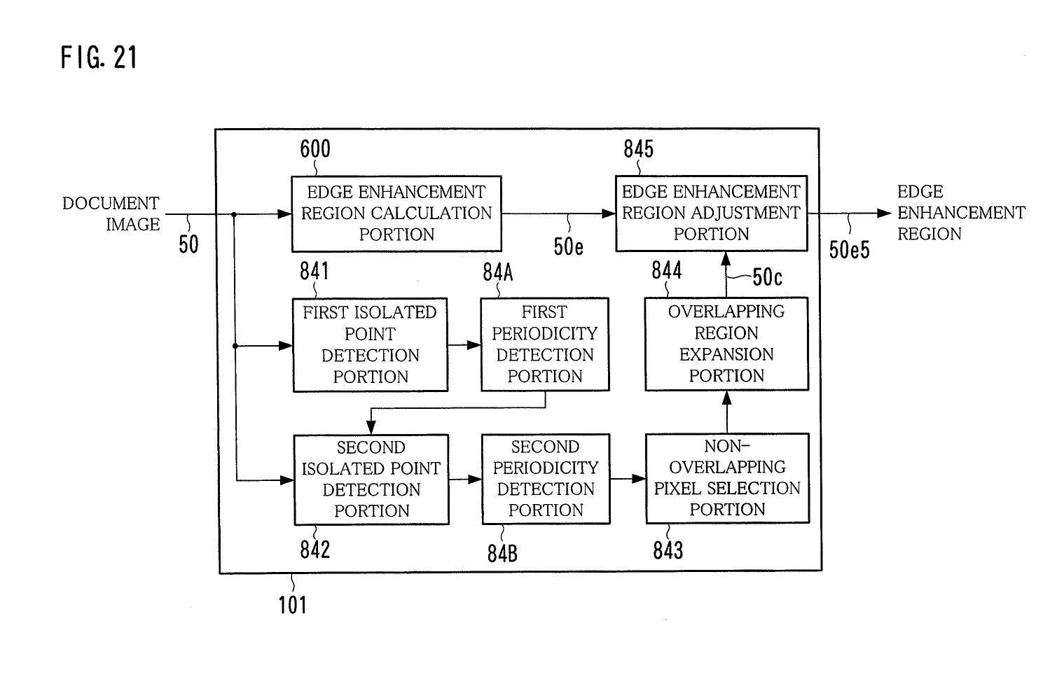

FIG. 21 is a diagram illustrating an example of the configuration of the edge enhancement region detection portion 101 for a case where the ninth edge enhancement region detection method is employed.

As with the cases of the fourth through eighth edge enhancement region detection methods, the ninth edge enhancement region detection method is suitably used for a case where the pattern of the translucent image 50a in the document image 50 reproduced based on the inputted image data 70 does not correspond to any of the patterns shown in FIGS. 6A and 6B.

Using the ninth edge enhancement region detection method improves the accuracy of the eighth edge enhancement region detection method.

Referring to FIG. 21, in the ninth edge enhancement region detection method, the edge enhancement region detection portion 101 is configured of an edge enhancement region calculation portion 600, a first isolated point detection portion 841, a first periodicity detection portion 84A, a second isolated point detection portion 842, a second periodicity detection portion 84B, a non-overlapping pixel selection portion 843, an overlapping region expansion portion 844, an edge enhancement region adjustment portion 845, and so on.

The first isolated point detection portion 841 uses a threshold γ1 to detect isolated point pixels in the document image 50, as with the case of the first isolated point detection portion 831 (see FIG. 19) according to the eighth edge enhancement region detection method.

The first periodicity detection portion 84A detects a periodicity (constant pattern) with which the isolated point pixels detected by the first isolated point detection portion 841 appear. The first periodicity detection portion 84A, then, detects a set of isolated point pixels for which a periodicity is observed.

The second isolated point detection portion 842 uses a threshold γ2 to detect isolated point pixels from among the set of isolated point pixels detected by the first periodicity detection portion 84A.

The second periodicity detection portion 84B detects a periodicity with which the isolated point pixels detected by the second isolated point detection portion 842 appear. The second periodicity detection portion 84B, then, detects a set of isolated point pixels for which a periodicity is observed.

The non-overlapping pixel selection portion 843 selects an isolated point pixel that is not included in the set of isolated point pixels detected by the first periodicity detection portion 84A and is included in the set of isolated point pixels detected by the second periodicity detection portion 84B.

The functions of the overlapping region expansion portion 844 and the edge enhancement region adjustment portion 845 are respectively the same as those of the overlapping region expansion portion 834 and the edge enhancement region adjustment portion 835. To be specific, the overlapping region expansion portion 844 detects an overlapping region 50c based on the region of isolated point pixels selected by the non-overlapping pixel selection portion 843. The edge enhancement region adjustment portion 845 detects an edge enhancement region 50e5.

[Tenth Edge Enhancement Region Detection Method]

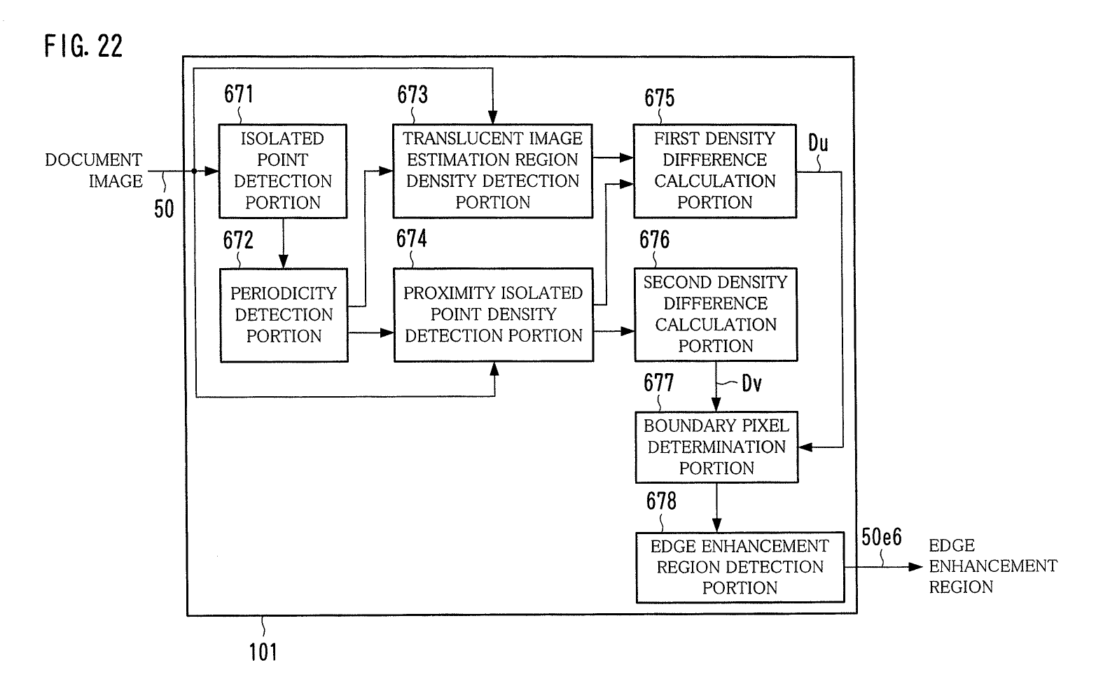

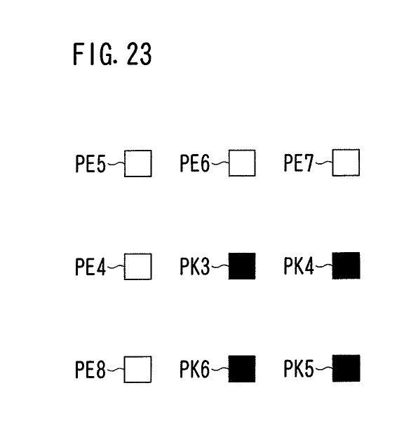

FIG. 22 is a diagram illustrating an example of the configuration of the edge enhancement region detection portion 101 for a case where the tenth edge enhancement region detection method is employed, and FIG. 23 is a diagram illustrating an example of the positional relationship between isolated point pixels and temporary isolated point pixels.

As with the cases of the fourth through ninth edge enhancement region detection methods, the tenth edge enhancement region detection method is suitably used for a case where the pattern of the translucent image 50a in the document image 50 reproduced based on the inputted image data 70 does not correspond to any of the patterns shown in FIGS. 6A and 6B.

Referring to FIG. 22, in the tenth edge enhancement region detection method, the edge enhancement region detection portion 101 is configured of an isolated point detection portion 671, a periodicity detection portion 672, a translucent image estimation region density detection portion 673, a proximity isolated point density detection portion 674, a first density difference calculation portion 675, a second density difference calculation portion 676, a boundary pixel determination portion 677, an edge enhancement region detection portion 678, and so on.

The isolated point detection portion 671 is operable to detect isolated point pixels in the document image 50. The periodicity detection portion 672 is operable to detect a periodicity (constant pattern) with which the isolated point pixels detected by the isolated point detection portion 671 appear. The periodicity detection portion 672, then, detects a set of isolated point pixels for which a periodicity is observed.

The translucent image estimation region density detection portion 673 detects the entire density of a region corresponding to the set of isolated point pixels detected by the periodicity detection portion 672, i.e., a region presumed to be a part of the translucent image 50a. In the case where, for example, a set of nine blacken isolated point pixels are detected as shown in FIG. 8, the translucent image estimation region density detection portion 673 detects, as the entire density, an average density of a region of 15×15 pixels including those nine isolated point pixels and non-isolated point pixels therearound.

The proximity isolated point density detection portion 674 detects, based on the periodicity and the like, a density of each of temporary isolated point pixels and other isolated point pixels which are placed in the vicinity of the isolated point pixels constituting the set of isolated point pixels detected by the periodicity detection portion 672. In this embodiment, the proximity isolated point density detection portion 674 detects a density of each of temporary isolated point pixels and eight other isolated point pixels that are disposed in the left, right, top, bottom, upper left, lower left, upper right, and lower right of each of the isolate point pixels.

Referring to FIG. 9, regarding the isolated point pixel placed at the center in the illustrated example, eight other isolated point pixels are disposed in its vicinity. Accordingly, the proximity isolated point density detection portion 674 detects a density of each of the eight other isolated point pixels.

Regarding the isolated point pixel placed in the upper left corner in the illustrated example (hereinafter this isolated point pixel is referred to as an “isolated point pixel PK3”), three other isolated point pixels (isolated point pixels PK4 through PK6) are disposed in the vicinity of the isolated point pixel PK3, i.e., in the right, left, and the lower right thereof. However, no isolated point pixels are disposed in the remaining five parts of the eight parts. The proximity isolated point density detection portion 674, then, detects a density of each of the isolated point pixels PK4 through PK6 shown in FIG. 23. The proximity isolated point density detection portion 674, further, detects a density of each of temporary isolated point pixels PE4 through PE8 determined based on the periodicity detected by the periodicity detection portion 672.

The first density difference calculation portion 675 and the second density difference calculation portion 676 perform the following processing on each of the isolated point pixels constituting the set of isolated point pixels detected by the periodicity detection portion 672.

The first density difference calculation portion 675 regards a certain isolated point pixel as a target. Hereinafter, the isolated point pixel regarded as the target is referred to as an “isolated point pixel of interest”.

The first density difference calculation portion 675 calculates a difference Du between the entire density detected by the translucent image estimation region density detection portion 673 and a density of either of two of isolated point pixels and temporary isolated point pixels that are symmetrical with respect to the isolated point pixel of interest. In the case where, for example, the isolated point pixel of interest is the isolated point pixel PK3 shown in FIG. 23, four different combinations of such isolated point pixels and temporary isolated point pixels are possible. Accordingly, the translucent image estimation region density detection portion 673 calculates four such differences Du. It is determined in advance which density of such isolated point pixels and temporary isolated point pixels is used to calculate the difference Du.

The second density difference calculation portion 676 calculates a difference Dv in density of two of isolated point pixels and temporary isolated point pixels that are symmetrical with respect to the isolated point pixel of interest. In the case where, for example, the isolated point pixel of interest is the isolated point pixel PK3 shown in FIG. 23, the second density difference calculation portion 676 calculates four such differences Dv.

Likewise, the first density difference calculation portion 675 and the second density difference calculation portion 676 regard each of the other isolated point pixels as a target, and obtains differences Du and Dv for the target isolated point pixel.

The boundary pixel determination portion 677 determines whether or not each isolated point pixel of interest is disposed near the boundary between the translucent image 50a and the rear image 50b in the following manner.

As for a certain isolated point pixel of interest, if each of the differences Du calculated by the first density difference calculation portion 675 exceeds the threshold γ3, then the boundary pixel determination portion 677 determines that the isolated point pixel of interest is disposed near the boundary between the translucent image 50a and the rear image 50b. Alternatively, as for a certain isolated point pixel of interest, if at least one of the differences Dv calculated by the second density difference calculation portion 676 exceeds the threshold γ4, then the boundary pixel determination portion 677 determines that the isolated point pixel of interest is disposed near the boundary between the translucent image 50a and the rear image 50b.

The edge enhancement region detection portion 678 uses closing processing and so on, to detect the region corresponding to the isolated point pixels determined to be disposed near the boundary between the translucent image 50a and the rear image 50b by the boundary pixel determination portion 677, then to output the detected region as an edge enhancement region 50e6.

[Eleventh Edge Enhancement Region Detection Method]

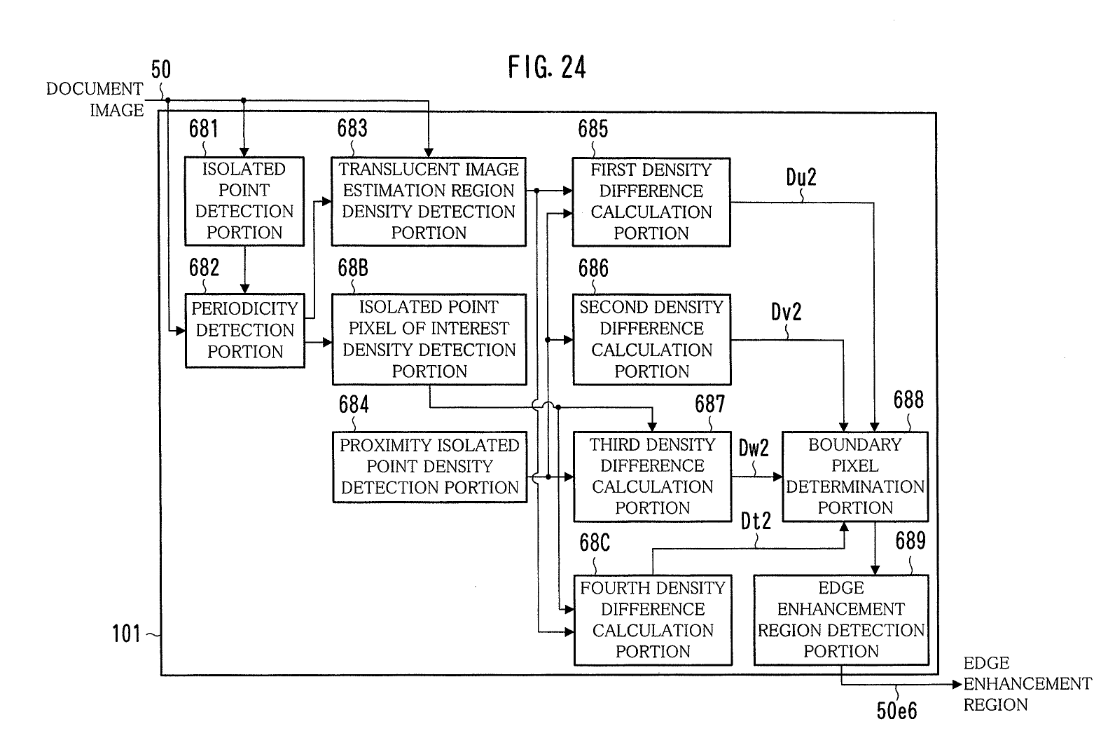

FIG. 24 is a diagram illustrating an example of the configuration of the edge enhancement region detection portion 101 for a case where the eleventh edge enhancement region detection method is employed.

As with the cases of the fourth through tenth edge enhancement region detection methods, the eleventh edge enhancement region detection method is suitably used for a case where the pattern of the translucent image 50a in the document image 50 reproduced based on the inputted image data 70 does not correspond to any of the patterns shown in FIGS. 6A and 6B.

Referring to FIG. 24, in the eleventh edge enhancement region detection method, the edge enhancement region detection portion 101 is configured of an isolated point detection portion 681, a periodicity detection portion 682, a translucent image estimation region density detection portion 683, a proximity isolated point density detection portion 684, a first density difference calculation portion 685, a second density difference calculation portion 686, a third density difference calculation portion 687, a boundary pixel determination portion 688, an edge enhancement region detection portion 689, an isolated point pixel of interest density detection portion 68B, a fourth density difference calculation portion 68C, and so on.

The functions of the isolated point detection portion 681 through the proximity isolated point density detection portion 684 are respectively the same as those of the isolated point detection portion 671 through the proximity isolated point density detection portion 674 (see FIG. 22) according to the tenth edge enhancement region detection method. The isolated point pixel of interest density detection portion 68B detects a density of an isolated point pixel of interest.

As with the first density difference calculation portion 675, the first density difference calculation portion 685 calculates a difference Du2 between the entire density detected by the translucent image estimation region density detection portion 683 and a density of either of two of isolated point pixels and temporary isolated point pixels that are symmetrical with respect to the isolated point pixel of interest.

As with the second density difference calculation portion 676, the second density difference calculation portion 686 calculates a difference Dv2 in density of two of isolated point pixels and temporary isolated point pixels that are symmetrical with respect to the isolated point pixel of interest.

The third density difference calculation portion 687 obtains a difference Dw2 between a density of the isolated point pixel of interest and each density of temporary isolated point pixels and other isolated point pixels of interest which are disposed in the vicinity of the isolated point pixel of interest (eight other isolated point pixels of interest or temporary isolated point pixels in the example of FIG. 23).

The fourth density difference calculation portion 68C calculates a difference Dt2 between the entire density and a density of the isolated point pixel of interest.

The boundary pixel determination portion 688 determines whether or not each isolated point pixel of interest is disposed near the boundary between the translucent image 50a and the rear image 50b in the following manner.

As for a certain isolated point pixel of interest, if each of the differences Du calculated by the first density difference calculation portion 685 exceeds the threshold γ5, then the boundary pixel determination portion 688 determines that the isolated point pixel of interest is disposed near the boundary between the translucent image 50a and the rear image 50b. Alternatively, as for a certain isolated point pixel of interest, if at least one of the differences Dv2 calculated by the second density difference calculation portion 686 exceeds the threshold γ6, then the boundary pixel determination portion 688 determines that the isolated point pixel of interest is disposed near the boundary between the translucent image 50a and the rear image 50b. Yet alternatively, two pixels that are symmetrical with respect to a certain isolated point pixel of interest are selected. The two pixels are any combination of isolated point pixels and temporary isolated point pixels. To be more specific, both the two pixels may be isolated point pixels or temporary isolated point pixels. One of the two pixels may be an isolated point pixel and the other may be a temporary isolated point pixel. If a difference Dwa between a density of one of the two pixels selected and a density of the certain isolated point pixel of interest is not equal to a difference Dwb between a density of the other of the two pixels and a density of the certain isolated point pixel of interest, then the boundary pixel determination portion 688 determines that the certain isolated point pixel of interest is disposed near the boundary between the translucent image 50a and the rear image 50b. Yet alternatively, if the difference Dt2 is equal to or smaller than the threshold γ7, then the boundary pixel determination portion 688 determines that the isolated point pixel of interest is disposed near the boundary between the translucent image 50a and the rear image 50b.

As with the edge enhancement region detection portion 678, the edge enhancement region detection portion 689 detects, as an edge enhancement region 50e6, the region corresponding to isolated point pixels determined to be disposed near the boundary between the translucent image 50a and the rear image 50b by the boundary pixel determination portion 688.

Referring back to FIG. 3, the edge enhancement processing portion 102 performs edge enhancement processing on the edge enhancement region 50e, 50e2, 50e3, 50e4, 50e5, or 50e6 in the document image 50 each of which is detected by the edge enhancement region detection portion 101 using any of the first through eleventh edge enhancement region detection methods.

For example, the edge enhancement processing portion 102 performs such edge enhancement processing by changing the color of the edge enhancement region 50e, 50e2, 50e3, 50e4, 50e5, or 50e6 to be the same as that of an isolated point pixel of the translucent image 50a. Alternatively, the edge enhancement processing portion 102 performs such edge enhancement processing by reducing the transmissivity of the edge enhancement region 50e, 50e2, 50e3, 50e4, 50e5, or 50e6 to be lower than that around the center of the translucent image 50a, or, in other words, by increasing the density of the edge enhancement region 50e, 50e2, 50e3, 50e4, 50e5, or 50e6.

The embodiments discussed above make it possible to detect an edge of the translucent image 50a more reliably than is conventionally possible. The embodiments, further, enable appropriate detection of an edge of the translucent image 50a even when the translucent image 50a and the rear image 50b overlap with each other as shown in FIG. 4A, and even when the translucent image 50a is expressed in gradations as shown in FIG. 13A.

In the embodiments, the first through eleventh edge enhancement region detection methods are taken as examples of a method for detecting an edge enhancement region. These methods may be used properly depending on the cases. For example, the edge enhancement region detection portion 101 is provided with the individual modules shown in FIGS. 10 through 12. In such a configuration, if obtaining attribute data 7A indicating the features shown in FIG. 6A, then the edge enhancement region detection portion 101 detects the edge enhancement region 50e through the second edge enhancement region detection method. If obtaining attribute data 7A indicating the features shown in FIG. 6B, then the edge enhancement region detection portion 101 detects the edge enhancement region 50e through the third edge enhancement region detection method. If obtaining attribute data 7A indicating the features shown in FIG. 6C, then the edge enhancement region detection portion 101 detects the edge enhancement region 50e through the fourth edge enhancement region detection method.

The edge enhancement region detection portion 101 may be provided with merely one of the individual modules that are shown in FIGS. 10 through 12 and have the same function as one another, and that one module may be mutually used in the second through fourth edge enhancement region detection methods.

In the embodiments discussed above, the overall configurations of the image forming apparatus 1, the configurations of various portions thereof, the content to be processed, the processing order, the configuration of the data, and the like may be altered as required in accordance with the subject matter of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A translucent image edge detection apparatus comprising:
a detector that detects isolated point pixels in an image, the isolated point pixels being pixels having a density higher than that of neighboring pixels adjacent to the isolated point pixels;
a determination portion that detects periodic pixels from the isolated point pixels, the periodic pixels being seen at regular intervals;
a closing processing portion that performs closing processing on a region containing the periodic pixels, and thereby, obtains a post-closing region;
an expanded region calculation portion that obtains an expanded region by expanding the post-closing region;
a reduced region calculation portion that obtains a reduced region by reducing the post-closing region; and
an edge calculation portion that detects an edge of a translucent image based on a difference between the expanded region and the reduced region.

2. The translucent image edge detection apparatus according to claim 1, further comprising
an undetected pixel selection portion that selects an undetected pixel, the undetected pixel being a pixel that is not detected by the detector and is disposed to be symmetrical to one of the isolated point pixels with respect to another one of the isolated point pixels, said another one of the isolated point pixels serving as a fixed point,
a non-edge pixel selection portion that, if a difference between a density of the undetected pixel and a density of said another one of the isolated point pixels serving as the fixed point is smaller than a threshold, and further, if a difference between a density of a pixel adjacent to the undetected pixel and a density of a pixel adjacent to said another one of the isolated point pixels is larger than a threshold, selects said another one of the isolated point pixels as a non-edge pixel, and
a non-edge part deletion portion that deletes, from the edge detected by the edge calculation portion, a part of the edge overlapping a region obtained by dilating the non-edge pixel.

3. The translucent image edge detection apparatus according to claim 1, further comprising
an undetected pixel selection portion that selects an undetected pixel, the undetected pixel being a pixel that is not detected by the detector and is disposed to be symmetrical to one of the isolated point pixels with respect to another one of the isolated point pixels, said another one of the isolated point pixels serving as a fixed point,
a non-edge pixel selection portion that, if a difference between a density of the undetected pixel and a density of said another one of the isolated point pixels serving as the fixed point is larger than a threshold, and further, if a difference between a density of a pixel adjacent to the undetected pixel and a density of a pixel adjacent to said another one of the isolated point pixels is smaller than a threshold, selects said another one of the isolated point pixels as a non-edge pixel, and
a non-edge part deletion portion that deletes, from the edge detected by the edge calculation portion, a part of the edge overlapping a region obtained by dilating the non-edge pixel.

4. A translucent image edge detection apparatus comprising:
a first detector that detects first isolated point pixels in an image, the first isolated point pixels being pixels having a first density higher than a density of neighboring pixels adjacent to the first isolated point pixels by a value of a first threshold or larger;
a second detector that detects second isolated point pixels in the image, the second isolated point pixels being pixels having a second density higher than a density of neighboring pixels adjacent to the second isolated point pixels by a value of a second threshold or larger, the second threshold being lower than the first threshold;
a selection portion that selects third isolated point pixels in the image, the third isolated point pixels being pixels that are not detected as the first isolated point pixels and are detected as the second isolated point pixels;
a third detector that detects an edge of a a deletion portion that deletes, from the edge detected by the third detector, a part of the edge overlapping a region obtained by dilating the third isolated point pixels.

5. The translucent image edge detection apparatus according to claim 4, wherein
the first detector detects, as the first isolated point pixels, a plurality of pixels that have the first density and are seen at regular intervals, and
the second detector detects, as the second isolated point pixels, a plurality of pixels that have the second density and are seen at regular intervals.

6. A translucent image detection apparatus comprising:
an isolated point pixel detector that detects isolated point pixels in an image, the isolated point pixels being pixels having a density higher than that of neighboring pixels adjacent to the isolated point pixels;
a determination portion that detects periodic pixels from the isolated point pixels, the periodic pixels being seen at regular intervals; and
a translucent image detector that detects, as a translucent image, a region obtained by dilating the periodic pixels.

7. The translucent image detection apparatus according to claim 6, further comprising an edge detector that detects an edge of the translucent image, and
an enhancement portion that enhances the edge.

8. A translucent image edge detection apparatus comprising:
a closing processing portion that, if attribute data of a translucent image indicates positions of pixels having at least a constant density in the translucent image, performs closing processing on an image showing distribution of the pixels, and thereby, obtains a post-closing region;
an expanded region calculation portion that obtains an expanded region by expanding the post-closing region;
a reduced region calculation portion that obtains a reduced region by reducing the post-closing region; and
a translucent image edge calculation portion that detects an edge of a translucent image based on a difference between the expanded region and the reduced region.

9. A translucent image edge detection apparatus comprising:
an obtaining portion that obtains attribute data indicating a position and a shape of a translucent image;
an expanded region calculation portion that obtains an expanded region by expanding a region of the translucent image based on the attribute data;
a reduced region calculation portion that obtains a reduced region by reducing a region of the translucent image based on the attribute data; and
a translucent image edge calculation portion that detects an edge of the translucent image based on a difference between the expanded region and the reduced region.

10. A translucent image edge detection method comprising:
first processing of detecting isolated point pixels in an image, the isolated point pixels being pixels having a density higher than that of neighboring pixels adjacent to the isolated point pixels;
second processing of detecting periodic pixels from the isolated point pixels detected in the first processing, the periodic pixels being seen at regular intervals;
third processing of performing closing processing on a region containing the periodic pixels detected in the second processing, and thereby to obtain a post-closing region;
fourth processing of obtaining an expanded region by expanding the post-closing region obtained in the third processing;
fifth processing of obtaining a reduced region by reducing the post-closing region obtained in the third processing; and
sixth processing of detecting an edge of a translucent image based on a difference between the expanded region and the reduced region.

11. The translucent image edge detection method according to claim 10, further comprising
seventh processing of selecting an undetected pixel, the undetected pixel being a pixel that is not detected in the first processing and is disposed to be symmetrical to one of the isolated point pixels with respect to another one of the isolated point pixels, said another one of the isolated point pixels serving as a fixed point, eighth processing of, if a difference between a density of the undetected pixel and a density of said another one of the isolated point pixels serving as the fixed point is smaller than a threshold, and further, if a difference between a density of a pixel adjacent to the undetected pixel and a density of a pixel adjacent to said another one of the isolated point pixels is larger than a threshold, selecting said another one of the isolated point pixels as a non-edge pixel, and ninth processing of deleting, from the edge detected in the sixth processing, a part of the edge overlapping a region obtained by dilating the non-edge pixel.

12. The translucent image edge detection method according to claim 10, further comprising seventh processing of selecting an undetected pixel, the undetected pixel being a pixel that is not detected in the first processing and is disposed to be symmetrical to one of the isolated point pixels with respect to another one of the isolated point pixels, said another one of the isolated point pixels serving as a fixed point, tenth processing of, if a difference between a density of the undetected pixel and a density of said another one of the isolated point pixels serving as the fixed point is larger than a threshold, and further, if a difference between a density of a pixel adjacent to the undetected pixel and a density of a pixel adjacent to said another one of the isolated point pixels is smaller than a threshold, selecting said another one of the isolated point pixels as a non-edge pixel, and eleventh processing of deleting, from the edge detected in the tenth processing, a part of the edge overlapping a region obtained by dilating the non-edge pixel.

13. A translucent image edge detection method comprising:
first processing of detecting first isolated point pixels in an image, the first isolated point pixels being pixels having a first density higher than a density of neighboring pixels adjacent to the first isolated point pixels by a value of a first threshold or larger;
second processing of detecting second isolated point pixels in the image, the second isolated point pixels being pixels having a second density higher than a density of neighboring pixels adjacent to the second isolated point pixels by a value of a second threshold or larger, the second threshold being lower than the first threshold;
third processing of selecting third isolated point pixels in the image, the third isolated point pixels being pixels that are not detected as the first isolated point pixels in the first processing and are detected as the second isolated point pixels in the second processing;
fourth processing of detecting an edge of a translucent image in the image; and
fifth processing of deleting, from the edge detected in the fourth processing, a part of the edge overlapping a region obtained by dilating the third isolated point pixels detected in the third processing.

14. The translucent image edge detection method according to claim 13, wherein
the first processing is to detect, as the first isolated point pixels, a plurality of pixels that have the first density and are seen at regular intervals, and
the second processing is to detect, as the second isolated point pixels, a plurality of pixels that have the second density and are seen at regular intervals.

15. A translucent image edge detection method comprising:
first processing of, if attribute data of a translucent image indicates positions of pixels having at least a constant density in the translucent image, performing closing processing on an image showing distribution of the pixels, and thereby to obtain a post-closing region;
second processing of obtaining an expanded region by expanding the post-closing region obtained in the first processing;
third processing of obtaining a reduced region by reducing the post-closing region obtained in the first processing; and
fourth processing of detecting an edge of the translucent image based on a difference between the expanded region obtained in the second processing and the reduced region obtained in the third processing.

16. A translucent image detection method comprising:
first processing of detecting isolated point pixels in an image, the isolated point pixels being pixels having a density higher than that of neighboring pixels adjacent to the isolated point pixels;
second processing of detecting periodic pixels from the isolated point pixels detected in the first processing, the periodic pixels being seen at regular intervals; and
third processing of detecting, as a translucent image, a region obtained by dilating the periodic pixels detected in the second processing.

17. The translucent image detection method according to claim 16, further comprising fourth processing of detecting an edge of the translucent image, and fifth processing of enhancing the edge detected in the fourth processing.

18. A translucent image edge detection method comprising:
first processing of obtaining attribute data indicating a position and a shape of a translucent image;
second processing of obtaining an expanded region by expanding a region of the translucent image based on the attribute data obtained in the first processing;
third processing of obtaining a reduced region by reducing a region of the translucent image based on the attribute data obtained in the first processing; and
fourth processing of detecting an edge of the translucent image based on a difference between the expanded region obtained in the second processing and the reduced region obtained in the third processing.
